(19) United States
(12) Patent Application Publication
(10) Pub. No.: US 2010/0076788 A1
(43) Pub. Date: Mar. 25, 2010

(54) Health-care exchange III

(76) Inventor: Anuthep Benja-Athon, New York, NY (US)

Correspondence Address: ANUTHEP BENJA-ATHON, 210 E 36yh Street, New York, NY, 10016, US

(21) Appl. No.: 12/584,718

(22) Filed: Sep. 11, 2009

Related U.S. Application Data
(63) Continuation-in-part of application No. 12/322,529, filed on Feb. 4, 2009.
Application No. 12/322,529 is a continuation-in-part of application No. 12/080,433, filed on Apr. 3, 2008.
Application No. 12/080,433 is a continuation-in-part of application No. 12/072,097, filed on Feb. 25, 2008.
Application No. 12/072,097 is a continuation-in-part of application No. 11/344,485, filed on Feb. 1, 2006.
Application No. 11/344,485 is a continuation-in-part of application No. 11/242,461, filed on Oct. 4, 2005, now abandoned.
Application No. 11/242,461 is a continuation-in-part of application No. 11/293,689, filed on Dec. 5, 2005, now abandoned.
Application No. 11/293,689 is a continuation-in-part of application No. 11/074,236, filed on Mar. 7, 2005, now abandoned.
Application No. 11/074,236 is a continuation-in-part of application No. 11/059,088, filed on Feb. 16, 2005, now abandoned.
Application No. 11/059,088 is a continuation-in-part of application No. 10/950,315, filed on Sep. 27, 2004, now abandoned.
Application No. 10/950,315 is a continuation-in-part of application No. 12/381,654, filed on Mar. 16, 2009.
Application No. 12/381,654 is a continuation-in-part of application No. 12/321,141, filed on Jan. 16, 2009.
Application No. 12/321,141 is a continuation-in-part of application No. 12/069,409, filed on Feb. 11, 2008.
Application No. 12/069,409 is a continuation-in-part of application No. 11/114,763, filed on Apr. 27, 2005, now abandoned.
Application No. 11/114,763 is a continuation-in-part of application No. 11/986,657, filed on Nov. 26, 2007.
Application No. 11/986,657 is a continuation-in-part of application No. 11/803,621, filed on May 16, 2007.
Application No. 11/803,621 is a continuation-in-part of application No. 11/716,062, filed on Mar. 9, 2007.
Application No. 11/716,062 is a continuation-in-part of application No. 11/649,873, filed on Jan. 5, 2007, now abandoned.
Application No. 11/649,873 is a continuation-in-part of application No. 11/637,662, filed on Dec. 13, 2006, now abandoned.
Application No. 11/637,662 is a continuation-in-part of application No. 11/599,847, filed on Nov. 16, 2006.
Application No. 11/599,847 is a continuation-in-part of application No. 11/431,046, filed on May 10, 2006.
Application No. 11/431,046 is a continuation-in-part of application No. 11/543,895, filed on Oct. 6, 2006, now abandoned.
Application No. 11/543,895 is a continuation-in-part of application No. 11/523,945, filed on Sep. 21, 2006.
Application No. 11/523,945 is a continuation-in-part of application No. 11/510,820, filed on Aug. 28, 2006, now abandoned.
Application No. 11/510,820 is a continuation-in-part of application No. 11/477,121, filed on Jun. 29, 2006, now abandoned.
Application No. 11/477,121 is a continuation-in-part of application No. 11/327,973, filed on Jan. 9, 2006, now abandoned.
Application No. 11/327,973 is a continuation-in-part of application No. 11/196,823, filed on Aug. 4, 2005, now abandoned.
Application No. 11/196,823 is a continuation-in-part of application No. 11/973,866, filed on Oct. 11, 2007.
Application No. 11/973,866 is a continuation-in-part of application No. 11/150,878, filed on Jun. 13, 2005, now abandoned.
Application No. 11/150,878 is a continuation-in-part of application No. 11/022,410, filed on Dec. 27, 2004, now abandoned.

(51) Int. Cl. G06Q 50/00; G06Q 10/00

(52) U.S. Cl. 705/3

(57) ABSTRACT

A system and a method for physicians, patients and health-care buyers to control their health-care resources by patterning and managing the dispensations of health-care services by physicians and patterning and managing the utilizations of health-care services by patients and for managing physicians' compensations and patients' and health-care buyers' health-care funds and disbursements.

This application is a continuation-in-part of Ser. No. 12/322,529 entitled the Healthcare Exchange II filed Feb. 4, 2009 whose response to the Jul. 9, 2009 Office action was filed Jul. 27, 2009, a continuation-in-part of Ser. No. 12/080,433 entitled the Healthcare Exchange filed Apr. 3, 2008, a continuation-in-part of Ser. No. 12/072,097 entitled A method of empowering owners of health-care resources filed Feb. 25, 2008, a continuation-in-part of Ser. No. 11/344,485 entitled Physicians-patients-health-care-buyers accounting system filed Feb. 1, 2006, a continuation-in-part of Ser. No. 11/242,461 entitled A perfect system of compensations for physicians filed Oct. 4, 2005, a continuation-in-part of Ser. No. 11/293,689 entitled A system of conserving health-care buyers' resources filed Dec. 5, 2005, a continuation-in-part of Ser. No. 11/074,236 entitled A system of management of health-care resources filed Mar. 7, 2005 (now abandoned), a continuation-in-part of Ser. No. 11/059,088 entitled The consumers-buyers-physicians-directed health-care filed Feb. 16, 2005 (now abandoned), Ser. No. 10/950,315 filed Sep. 27, 2004, a continuation-in-part of Ser. No. 12/381,654 entitled the Adaptable Compositions of Health Information filed Mar. 16, 2009, a continuation-in-part of Ser. No. 12/321,141 entitled The best system of health and health-care data management filed Jan. 16, 2009, a continuation-in-part of Ser. No. 12/069,409 entitled the Filing of Health and Health-care data filed Feb. 11, 2008, a continuation-in-part of Ser. No. 11/114,763 entitled A system of influencing health-care utilizations filed Apr. 27, 2005 (now abandoned), a continuation-in-part of Ser. No. 11/986,657 entitled A hierarchy of medical word headers filed Nov. 26, 2007, a continuation-in-part of Ser. No. 11/803,621 entitled Patients' and physicians' data management filed May 16, 2007, a continuation-in-part of Ser. No. 11/716,062 entitled A sieve of words in health-care data filed Mar. 9, 2007, a continuation-in-part of Ser. No. 11/649,873 entitled A system of calibrating physicians' practices of medicine filed Jan. 5, 2007 (now abandoned), a continuation-in-part of Ser. No. 11/637,662 entitled A vital hierarchy of data on diseases filed Dec. 13, 2006, a continuation-in-part of Ser. No. 11/599,847 entitled A hybrid intelligence in medicine filed Nov. 16, 2006, a continuation-in-part of Ser. No. 11/431,046 entitled A system of health-care information management filed Nov. 2, 2006, a continuation-in-part of Ser. No. 11/543,895 entitled Vital elements of speech recognition filed Oct. 6, 2006, a continuation-in-part of Ser. No. 11/523,945 entitled The networking of digital health information filed Sep. 21, 2006, a continuation-in-part of Ser. No. 11/510,820 entitled Words for managing health and health-care information filed Aug. 28, 2006 (now abandoned), a continuation-in-part of Ser. No. 11/477,121 entitled the Medical Vocabulary Templates in Speech Recognition filed Jun. 29, 2006 (now abandoned), a continuation-in-part of Ser. No. 11/327,973 entitled Fidelity of physicians' thoughts to digital data conversions filed Jan. 9, 2006, a continuation-in-part of 11/196,823 entitled Routing of health information files filed Aug. 4, 2005 (now abandoned), a continuation-in-part of Ser. No. 11/973,866 entitled An intelligent system of speech recognizing physicians' data, a continuation-in-part of Ser. No. 11/150,878 entitled Physicians' optimal management of health information filed Jun. 13, 2005, and a continuation-in-part of Ser. No. 11/022,410 entitled Physicians' way of information productions filed Dec. 27, 2004 (now abandoned) which are pending.

### FIELD OF INVENTION

The management of information and data on health care and health-care services for patterning the dispensations and utilizations of health-care services.

### BACKGROUND OF THE INVENTION

The current health-care system conceived and supported by the archaic system widely use in America is inefficient and, over the decades, has grown into an even more inefficient system which degrades the quality of health-care for people, hinders and impedes the health-care progresses and advancements, increase costs for people, keeps health-care costs high and escalating the health-care costs, impose emotional, physical and financial stresses on physicians, patients and companies and corporations, lowers the standard of living and quality of life and, in tangible terms, wastes hundreds of billions of dollars per annum. Physicians, patients, companies, corporations, Congress, government—alone or combined with immensely vast resources—have heretofore neither know-how nor means to free themselves left alone tackle these crises they are in. Recent enacted laws and regulations have not provide the solution to the enormous crisis being faced by American people.

However, the present invention is a vital component part of the unique and innovative systems and methods for solving said problems and crises of the present patent applicant and his co-inventors and together with the pending inventions of the present patent applicant and his co-inventors contribute to the solution to said problems and crises.

Respectfully, there exists neither prior art suggesting nor teaching the present physician applicant's said patent applications including the present application as indicated by earlier Office's actions and as pointed out by and shown in said applications, the present application and this applicant's responses to the earlier Office actions such as, but not limited to, the applicant's submitted Jul. 24, 2009 amendment in response to the Jul. 9, 2009 Office action on the applicant's application Ser. No. 12/322,529 entitled the Healthcare Exchange II filed Feb. 4, 2009.

The present invention improves or optimizes the practices of medicine and surgery of and by physicians and the uses of health care and health-care services by patients who are informed, reminded, guided and urged and improve patients' health and health care and said dispensations and utilizations of health care and health-care services, the continuity of health care and health-care services involving physicians and patients, the dispensations, utilizations and deliveries and quality of health care and health-care services, the dispensations, utilizations and deliveries and quality of health care and health-care services, the improvement of the attitudes, perceptions, understandings, comprehension and behaviors of patients towards health such as, chronic diseases and disorders and their relationships to health, health care and health-care services, the reductions of wastes and duplicate dispensations, utilizations and deliveries of health care and health-care services, the reduction or minimize physicians' time waste, costs and losses and patients' health and health-care costs or losses while provides for the improvement of their quality, the deliveries of and the accesses to health care and health-care services, the physicians' productivity, the reduction of stresses, morbidity and mortality, the quality and practice of medicine and surgery, the reduction of medical negligence, mistakes and errors, malpractice and legal liabilities of and legal actions and litigations against physicians.

The present invention is the unique method and innovative system for solving the health-care crises in America wherein informed and educated physicians, patients and health-care buyers have the one and only means for directly controlling, allocating, accounting and influencing their resources while reducing or eliminating interferences, hindrances and hundreds of billions of dollars of wastes and losses. The benefits to hundreds of millions of people including physicians, patients and health-care buyers—who are heretofore free from their decades-long and escalating pain and suffering—and the nation are enormously immense. Said inventions produce the best health-care system the world ever known and have and the benefits for billions of people and humanity are immense.

### SUMMARY OF THE INVENTION

The present invention together with said pending patent applications are the only means and solution for solving the current health and health-care woes affecting all Americans and, consequently, they produce the best health-care system the world ever known and have and the benefits for billions of people and humanity are immense.

The present invention is an even-more-potent, artificial-intelligent health-care system and method for physicians, patients and health-care buyers to control their health-care resources by patterning, influencing and managing the dispensations of health care and health-care services to patients of or by physicians and patterning, influencing and managing the utilizations of health care and health-care services of or by patients and for managing physicians' compensations for health care and health-care services provided to patients and for managing patients' and health-care buyers' health-care funds and disbursements in a network or networks of computers and computer servers wherein vital words and terms, the integral components of information and data on or relating to health, health-care and health-care services, and related data on monetary values generated, used and submitted by physicians are stored, related, compiled and managed in the database or databases in and manage by SQL server and are used by innovative computer programs and software to generate, manage, account and display detailed, extensive and logical information and data outcomes and products on or relating to health, health care and health-care services and related said compensations and said disbursements which are retrieved, viewed, managed, used and expanded by physicians and patients.

### DESCRIPTION OF THE PREFERRED EMBODIMENTS

The present invention is a system and a method for physicians, patients and health-care buyers to control their health-care resources by patterning, influencing and managing patterning and managing the dispensations of health care and health-care services to patients of or by physicians and patterning and managing the utilizations of health care and health-care services of or by patients and for managing physicians' compensations for health care and health-care services provided to patients and for managing patients' and health-care buyers' health-care funds and disbursements in a network or networks of computers, portable and/or wireless communication devices and operating and functioning computer servers.

One of the preferred embodiments of the present invention and said patent applications, physicians of about 85 medical and surgical specialties or practices using computers and/or mobile communication devices from diverse and different locations via the Internet to access, generate, submit, retrieve, use, manage and expand information and data on health, health care and health-care services and related information and data infra on and relating to patients and physicians in the database or databases in and manage by SQL server in a network or networks of computers, portable and/or wireless communication devices and operating and functioning computer servers comprising a plurality of processors, memories, server operating system, a networking capability comprising a Web browser and Web server, SQL server, computer scripting language programs and innovative computer programs and software communicating with and commanding said SQL server. Per routine, said physicians login and complete subsequent routine processes and security for accessing said information and data in said database or databases in and manage by said SQL server in said computer server or servers.

To understand the preferred embodiments of the present invention, however, it is necessary to mention herein said earlier patent applications including pending patent applications such as, but not limited to, Ser. No. 12/381,654 entitled the Adaptable Compositions of Health Information, Ser. No. 12/321,141 entitled The Best System of Health and Health-care Data Management Ser. No. 12/069,409 entitled the Filing of Health and Health-care data, Ser. No. 12/322,529 entitled the Healthcare Exchange II and Ser. No. 12/080,433 entitled The Healthcare Exchange. Said unique and innovative patent applications taught the use and implementation of the categories, headers or headings such as, but not limited to, Evaluation, Chief Complaint, Diagnosis, Treatment, Procedure, Surgery, Medication and Laboratory to enable and/or facilitate the organization, manipulation, processing and relating of health, health-care and health-care services generated and submitted by physicians in about 85 medical and surgical specialties. Each said heading encompasses a vast amount of information and data including words and terms on or relating to health, health-care and health-care services which are used by physicians of all and diverse medical and surgical practices or specialties for and in the communications of said information and data among and between said physicians and between physicians and patients. Said information and data including said words and terms are found in numerous medical dictionaries and medical and surgical text books, journals, publications, literature and encyclopedias, etc. of said all medical and surgical specialties. For example, in the Evaluation heading, said words and terms number about 20-40 or more and are such as, but not limited to, consultation, brief consultation, intermediate consultation, comprehensive consultation, office visit, brief office visit, intermediate office visit, examination, reexamination, follow-up, etc.; in the heading of Laboratory comprises imaging, blood and tissue tests, analyses and examinations, electrodiagnosis, said words and terms number approximately many hundreds such as, but not limited to, x-rays, MRI's, CTScan's, PET Scans of various parts of the body, various types of blood tests, urinalyses, pathological analyses which are used by physicians in about 85 medical and surgical specialties or practices. However, in each of other said headings, said words and terms are very extensive. For example, under Diagnosis heading, there are all words and terms used and use by physicians in about 85 medical and surgical specialties on diagnoses of human diseases, illnesses and disorders; in Treatment heading, there are all words and terms used and use by physicians in about 85 medical and surgical specialties on the treatments of human diseases, illnesses and disorders such as, but not limited to, medical acupuncture, excision drainage, trigger point injection, bursa injection, vaccinations, etc.; in the Surgery heading, there are all words and terms used and use by physicians in about 85 medical and surgical specialties on the surgeries and surgical procedures of human diseases, illnesses and disorders such as, but not limited to, burr hole, craniotomy, cholecystectomy, splenectomy, arthroscopy, endoscopy, resections, etc.; in Medication heading, there are all medications and related information present in the Physicians' Desk Reference used and use by physicians in about 85 medical and surgical specialties. Anatomical structures and names are also used.

Further to supra, said pending applications and the present invention provide a process of scanning and checking of said words and terms, in particular scanning and matching said words and terms encompassed by the headers of Diagnosis, Evaluation, Laboratories, Imaging, Body Fluid Tests and Tissues Examination, Medications, Treatment, Surgery generated and used and submitted by physicians representing health care and health-care services provided to patients by physicians, see also infra, with said words and terms same as, similar to and/or equivalence of said words and terms and relating prices, monetary values or costs of said services in the database or databases in and manage by said SQL to generate accounts of payments, distributions, redistributions of payments, disputes, appeals, credits, debits, refunds, balances, revenues and earnings of individual physicians and debits, credits, refunds, deductions and/or disbursements from patients' and/or health-care buyers' deposits and/or funds corresponding to said payments, compensations and/or distributions to said physicians by and/or on the behalf of said patients and by and/or on the behalf of said health-care buyers generated, submitted, stored, related and compiled in the database or databases in and manage by said SQL server.

Said information and data including said words and terms are integral components of said health, health-care and health-care-service information and data on or relating to diseases and disorders and patients used and use by physicians of all and diverse medical and surgical practices or specialties for and in the communications of said information and data among and between physicians and between physicians and patients. Said information and data including said words and terms on or relating to health, health care and health-care services provided to patients by physicians are generated and submitted by physicians to be stored, related and compiled or pooled in the database or databases in and manage by said SQL server. Said information and data including said words and terms are continually and perpetually generated and submitted by physicians and are stored, related, compiled in the database or databases in and manage by said SQL server.

In addition, briefly herein although detailed in said pending patent applications, said information and data including words and terms on or relating to health care and health-care services are generated, submitted, stored, related, compiled or pooled in the database or databases in and manage by said SQL server and are retrieved—using computer mice, keyboards, physicians' or patients' fingers on the touch-enabled viewing screens and/or voice-activation and the like—by and displayed to physicians and patients as numerous interactive pop-up and/or drop-down lists and/or menus of words, terms, phrases, sentences, texts, synonyms, acronyms, texts, numbers, graphics, and word and term headers or headings comprising information and data on and relating to said DIAGNOSES on diseases, disorders, health, health-care and health-care services use by physicians of about 85 medical and surgical specialties and practices. Moreover, interactive graphics such as, but not limited to, U.S. Pat. No. 6,132,218 which can be clicked to present pop-up and/or drop-down lists and/or menus of words, terms, phrases, sentences, texts, synonyms, acronyms, texts, numbers, graphics, and word and term headers or headings comprising information and data on and relating to said DIAGNOSES on diseases, disorders, health, health-care and health-care services use by physicians of about 85 medical and surgical specialties and practices viewable and useable by said physicians and/or patients. Furthermore, in the preferred embodiments of said patent applications and the present invention, said word and term headers comprise Diagnosis, Evaluation, Chief Complaint, Review of Systems, Physical Examination, Infectious Diseases, Differential Diagnosis, Laboratories such as, but not limited to, Imaging, Body Fluid Tests and Tissues Examination, Assessment and Plan, Medications, Treatment, Surgery, Recommendations, Guidelines, Referral and Follow-up wherein said information and data including said words and terms are found and/or related.

Said processes leading to the generations and retrievals of numerous interactive pop-ups and/or drop-down lists and/or menus and interactive graphics are used in interactive electronic templates for clicking and/or selecting and generating and submitting said information and data including words and terms already related, compiled and stored in the database or databases in said SQL server wherein said information and data including said words and terms are retrieved and used—and less keyboarding and therefore less potential errors and more consistent information and data being generated/used and submitted—by physicians to achieve the goals and objectives of the present invention. At least Java Script and AJAX are used to support interactive pop-ups and/or drop-down lists and/or menus and interactive graphics.

Therefore, physicians of about 85 medical and surgical specialties or practices using computers and/or mobile communication devices from diverse and different locations access said computer server or servers via the Internet can retrieve said interactive electronic templates to generate and/or use and submit said information and data including words and terms on or relating to diagnoses of diseases and disorders and related health, health-care and health-care services.

However, among said preferred embodiments of said pending patent applications and the present invention is a preferred embodiment wherein physicians still have the option of keyboarding to generate said information and data including said words and terms.

Further to supra, one of the preferred embodiments of said inventions and the present invention is the generation, relating and storage of said information and data including said words and terms and words and terms same as, similar and/or equivalent to said words and terms generated and submitted by said physicians as described supra—in the database or databases of said SQL server and have been generated and implemented by the present patent applicant and the quantity of said words and terms will continue to grow and enlarge as more words and terms are generated, entered and stored in the database or databases in and manage by said SQL server.

Further to supra, words and terms same as, similar and/or equivalent to said words and terms generated and/or used and submitted by physicians under the headers of health-care and health-care services comprises Diagnosis, Evaluation, Laboratories, Imaging, Body Fluid Tests and Tissues Examination, Medications, Treatment, Surgery are stored and related in the database or databases in said SQL and are related to monetary values representing prices or monetary values of said health-care and health-care services generated, related and stored in said database or databases in said SQL server. Similar to supra, said words and terms and relating monetary values or prices have been generated and implemented by the present patent applicant and the quantity of said words and terms will continue to grow and enlarge as more words, terms, prices or monetary values are generated, entered and stored in said database or databases. Said prices or monetary values are the billing rates—the costs or prices—for health-care and health-care services represent by the fees and payments for items represent by said words and terms for about 85 medical and surgical specialties such as neurology, orthopaedics, general surgery, etc. can be established as data in the database or databases in and manage by said SQL server and frequently added and/or edited.

Said unique and innovative pending patent applications and present invention further taught the scanning of submitted information and data including words and terms on health care and health-care services provided to patients by physicians generated and/or used by physicians, as described supra, with words and terms same as, similar to and/or equivalence of said words and terms in the database or databases and checking for redundant repeats, doubles or similars and/or errors. Redundant repeats, doubles or similars and/or errors in the submitted information and data are fixed so that there is no redundant repeat, double or similar submitted or present in the database or databases, and physicians are shown erroneous words and terms generated and submitted by said physicians so that said physicians are able to change, correct or edit erroneous words and terms.

Similarly, first, said unique and innovative patent applications and the present invention further taught the use of said words and terms are integral components of said health, health-care and health-care-service information and data on or relating to diseases and disorders and patients used and use by physicians of all and diverse medical and surgical practices or specialties for and in the communications of said information and data among and between physicians and between physicians and patients generated and used and submitted to the database or databases in and manage by said SQL server, the use of said words and terms same as, similar to and/or equivalence of said words and terms and relating prices, monetary values or costs of said services generated, submitted, stored, related and compiled in the database or databases in and manage by said SQL server and the scanning, checking and matching of said words and terms, in particular said words and terms encompassed by the headers of Diagnosis, Evaluation, Laboratories, Imaging, Body Fluid Tests and Tissues Examination, Medications, Treatment, Surgery generated and used and submitted by physicians representing health care and health-care services provided to patients by physicians, as described supra, with said words and terms same as, similar to and/or equivalence of said words and terms and relating prices, monetary values or costs of said services in the database or databases in and manage by said SQL. Consequently, said words and terms enable and effect by said innovative computer programs and software and computer scripting languages and said SQL in said computer server or servers to generate information and data outcomes and products comprising payments, distributions, redistributions of payments, disputes, appeals, credits, debits, refunds, balances, revenues and earnings of individual physicians and debits, credits, refunds, deductions and/or disbursements from patients' and/or health-care buyers' deposits and/or funds corresponding to said payments, compensations and/or distributions to said physicians by and/or on the behalf of said patients and by and/or on the behalf of said health-care buyers generated, submitted, stored, related and compiled in the database or databases in and manage by said SQL server. Furthermore, by using said words and terms, patients are enabled to dispute payments to physicians, to hold payments in abeyance, physicians are enabled to respond to patients' disputes and to implement payments to physicians. In other words, said preferred embodiments effect and provide the automatic generations, managements and maintenances of individual payments, distributions, redistributions of payments, disputes, appeals, credits, debits, refunds, balances, revenues and earnings of individual physicians and debits, credits, refunds, deductions and/or disbursements from patients' and/or health-care buyers' deposits and/or funds corresponding to said payments or compensations to said physicians by and/or on the behalf of said patients and by and/or on the behalf of said health-care buyers in the database or databases in and manage by said SQL server.

Second, further to supra and achievable with said processes, said information and data and information and data outcomes and products consequent to said uses and processing of words and terms which are integral components of said health, health-care and health-care-service information and data on or relating to diagnoses, diseases and disorders and related information and data infra and patients used and use by physicians of all and diverse medical and surgical practices or specialties for and in the communications of said information and data among and between physicians and between physicians and patients generated and used and submitted to the database or databases in and manage by said SQL server, of words and terms same as, similar to and/or equivalence of said words and terms and relating prices, monetary values or costs of said services generated, submitted, stored, related and compiled in the database or databases in and manage by said SQL server and the scanning, checking and matching of said words and terms, in particular said words and terms encompassed by the headers of Diagnosis, Evaluation, Laboratories, Imaging, Body Fluid Tests and Tissues Examination, Medications, Treatment, Surgery generated and used and submitted by physicians representing health care and health-care services provided to patients by physicians, as described supra, with said words and terms same as, similar to and/or equivalence of said words and terms and relating prices, monetary values or costs of said services in the database or databases in and manage by said SQL server, one of the preferred embodiments of the present invention provides and effects the automatic generations, managements and maintenances of adjustable—higher or lower or variable—payments, adjustments to individual payments, distributions or redistributions of payments pertaining or relating to individual diagnoses and relating procedures and treatments delivered by individual physicians or individual groups of physicians of same or diverse medical and surgical specialities who are involved in the health care of and/or provide health-care services to individual patients. Using said words and terms in said categories or headings of Diagnosis, Evaluation, Laboratories, Imaging, Body Fluid Tests and Tissues Examination, Medications, said outcomes and products are used by the present invention to provide the accounting and displaying of payments, distributions, redistributions, adjustments, disputes, appeals, credits, debits, refunds, balances, revenues and earnings of physicians and/or individual physicians or individual groups of physicians providing health care and health-care services to individual patients on or relating to individual diagnoses generated, stored, related in the database or databases in and managed in said SQL server. In other words, said innovative computer programs and software of the present invention further provide the continual proportional distributions and adjustments or redistributions of payments to individual physicians or individual groups of physicians of same or diverse medical and surgical specialties pertaining or relating to individual diagnoses and relating services, procedures and treatments delivered by individual physicians or individual groups of physicians of same or diverse medical and surgical specialities who are involved in the health care of and/or provide health-care services to individual patients. In other words, the present invention provides processes for managing, manipulating and using the components of said information and data and information and data outcomes and products in the database or databases in and manage by said SQL server to generate arrangements or combinations of diverse payment arrangements or payment schedules of said services, procedures and treatments provided to patients by physicians to individual physicians or individual groups of physicians ranging from a first payment schedule wherein individual diagnoses relate to individual payments are only paid to individual physicians providing said services to individual patients to a second payment schedule wherein proportional distributions or adjustments or redistributions of payments among physicians of same and/or diverse medical and/or surgical specialties pertaining or relating to individual diagnoses and relating services, procedures and treatments delivered by said individual groups of physicians who are involved in and/or have provided health care and health-care services to individual patients. Furthermore, individual words and terms representing evaluations, procedures, treatments, surgeries, medications, laboratories and tests, etc. in said headers are related to prices, monetary values or costs representing prices, monetary values or costs of said health care and health-care services provided to patients by physicians in same or different and diverse localities. In other words, a simplistic explanation of an expansive system—for a given diagnosis established for a patient by a physician providing health-care service or services to said patient from the beginning to the end of said health care for said diagnosis, said physician's account is credited in full payment. However, on the other hand, if said physician in said setting involve other physician or physicians of same or different medical and surgical specialties providing health care and health-care services to said patient and/or said other physician or physicians involve more physician or physicians to provide health care and health-care services to said patient, then all physicians providing health care and health-care services pertinent to said given diagnosis share proportions or percentages of an assigned fee, fees or combined fees of said health care and health-care service or services.

For first example, to simplistically explain said numerous, complex and diverse payment arrangements or schedules, a Comprehensive Consultation is assigned a monetary value of $200 and an Injection is assigned monetary value of $150 in Washington, D.C. and an antibiotics is assigned a price of $30. In a setting in Washington, D.C., a patient sees a physician A who administered said two procedures and said antibiotics based on a diagnosis of Cellulitis. If said patient's diagnosis is correct and patient is cured wherein the establishment of said diagnosis resulted in said procedures and use of said appropriate antibiotics, said physician A's account in said database or databases in and manage by said SQL is credited with said sum of $380.

On the other hand, however, to explain said numerous, complex and diverse payment arrangements or schedules using simple example, said physician A is not successful in curing said patient and, based on a diagnosis of Cellulitis, needs to refer said patient to another physician B of same specialty or different specialty such as an infectious disease physician B who provides a Simple Consultation assigned a monetary value of $50 and an oral antibiotics of $10 and physician B is able to cure said patient. In said entire setting, the proportional payments to physician A minus the payments to physician B as a result of applying a deduction to earlier physician A's payments are Comprehensive Consultation $200—Simple Consultation $50=$150 representing reduced payment credited to physician A's account, said injected antibiotics $30—said oral antibiotics $10=$20 representing reduced payment credit to physician A' account. The outcome of yet another simple example representing numerous, complex and diverse payment arrangements or schedules, is that physician A's account is readjusted or debited and credited with only $150+$150+$20=$320 and some of said money is redistributed to physician B's account which is credited with only $50+$10=$60.

For second example, to further simplistically explain said numerous, complex and diverse payment arrangements or schedules using yet another simple example, a Brief Consultation is assigned a monetary value of $100 and an Injection is assigned monetary value of $75 in Florida and an antibiotics is assigned a price of $15 and a throat culture is assigned a price of $10. In a setting in Florida, a second patient B sees a physician X who administered said three procedures and said antibiotics based on a diagnosis of throat infection. If said patient's diagnosis is correct and patient is cured wherein the establishment of said diagnosis resulted in said procedures and use of said appropriate antibiotics, said physician X's account in said database or databases in and manage by said SQL is credited with said sum of $200.

On the other hand, explaining said one example, said physician X is not successful in curing said patient and, based on a diagnosis of throat infection, patient B see another physician Y of same specialty or different specialty such as another general practitioner physician Y who provides another or second Brief Consultation assigned a monetary value of $50 and an oral antibiotics of $5 and physician Y is able to cure said patient. In said entire setting, the proportional payments to physician X minus the payments to physician Y as a result of applying a deduction to earlier physician X's payments are Brief Consultation $100−Simple Consultation $50=$50 representing reduced payment credited to physician X's account, said injected antibiotics $15−said oral antibiotics $5=$10 representing reduced payment credit to physician X' account. The outcome of yet another simple example representing numerous, complex and diverse payment arrangements or schedules, is that physician X's account is readjusted or debited and credited with only $50+$10+$10=$70 and some of said money is redistributed to physician Y's account which is credited with $50+$10=$55. More physicians may be involved in this setting to result in redistributions—known or unknown to said physicians—of said money pertaining to said patient and said diagnosis or yet another diagnosis.

Further to and relating to supra, correspondingly, proportional debits, deductions and/or disbursements from patients' and/or health-care buyers' deposits and/or funds correspond to said payments, distributions, redistributions, adjustments to said physicians by and/or on the behalf of said patients and by and/or on the behalf of said health-care buyers are submitted, stored and related in the database or databases in and manage by said SQL server. Similarly, said processes also account for said disputes, appeals, credits, refunds and balances in the database or databases in and manage by said SQL server.

The present invention provides a process of retrieving and displaying and using said words and terms which are made interactive with individual patients and individual physicians to generate, display and use individual arrays or series of information and data on or relating to health, health-care, health-care services provided to individual patients by individual physicians such as, but not limited to, individual Diagnoses of diseases, disorders and illnesses of individual patients and diagnosis-related information and data such as, but not limited to, Evaluations, Chief Complaints, Allergies, Family Histories, Vital Sign Measurements, Reviews of Systems, Physical Examinations, Infectious Diseases, Differential Diagnoses, Results of Laboratories such as, but not limited to, Imagings, Body Fluid Tests and Tissues Examinations, Assessments and Plans, Immunizations, Medications, Treatments, Surgeries, Recommendations, Guidelines, Referrals and Follow-ups generated and submitted by patients and physicians in the database or databases in and manage by said SQL server by individual patients and individual physicians. For example, using a word or a term representing a Diagnosis which is made interactive with a patient and his or her physicians on the viewing screens who have access to said information and data, by clicking said interactive word or term representing said Diagnosis, said patient and physicians can generate, display, view and use an array or a series of information and data on said Diagnosis and all relating health, health-care, health-care services such as, but not limited to, his or her said diagnosis on the disease, disorder or illness and all his or her Evaluation(s), Chief Complaint(s), Allergy(ies), Family History, Vital Sign Measurement(s), Review(s) of Systems, Physical Examination(s), Infectious Disease(s), Differential Diagnosis(ses), Result(s) of Laboratory(ies) such as, but not limited to, Imaging(s), Body Fluid Test(s) and Tissue(s) Examination(s), Assessment(s) and Plan(s), Immunizations, Medication(s), Treatment(s), Surgery(ies), Recommendation(s), Guideline(s), Referral(s) and Follow-up(s).

Further to supra, in addition to said generations, displays and uses of said individual arrays or series of information and data on or relating to health, health-care, health-care services, using said processes, related information and data on payable health-care services, treatments, procedures, tests and laboratories and said related accounting, utilizations, expenses, disbursements, payments, redistributions, adjustments, credits, account payables, receivables, collectibles and unpaid charges of services, revenues and earnings are also generated, displayed and used, appropriately, by individual patients and individual physicians.

Furthermore, the present invention also provides a process of retrieving, displaying and using said words and terms which are made interactive with patients and physicians to generate, display and use individual arrays or series of related pooled or compiled information and data on health, health-care, health-care services provided to patients by physicians such as, but not limited to, individual Diagnoses of diseases, disorders and illnesses of patients and diagnosis-related information and data in such as, but not limited to, Evaluations, Chief Complaints, Allergies, Family Histories, Vital Sign Measurements, Reviews of Systems, Physical Examinations, Infectious Diseases, Differential Diagnoses, Results of Laboratories such as, but not limited to, Imagings, Body Fluid Tests and Tissues Examinations, Assessments and Plans, Immunizations, Medications, Treatments, Surgeries, Recommendations, Guidelines, Referrals and Follow-ups generated and submitted by patients and physicians in the database or databases in and manage by said SQL server by patients and physicians. For example, using a word or a term representing a Diagnosis which is made interactive with patients and physicians on the viewing screens who have access to said information and data, by clicking said interactive word or term representing said Diagnosis, patients and physicians can generate, display, view and use individual arrays or series of related pooled or compiled information and data on health, health-care, health-care services provided to patients by physicians on said Diagnosis and all diagnosis-relating health, health-care, health-care services such as, but not limited to, Evaluations, Chief Complaints, Allergies, Family Histories, Vital Sign Measurements, Reviews of Systems, Physical Examinations, Infectious Diseases, Differential Diagnoses, Results of Laboratories such as, but not limited to, Imagings, Body Fluid Tests and Tissues Examinations, Assessments and Plans, Immunizations, Medications, Treatments, Surgeries, Recommendations, Guidelines, Referrals and Follow-ups.

Further to supra, in addition to said generations, displays and uses said individual arrays or series of related pooled or compiled information and data on health, health-care, health-care services provided to patients by physicians, using said processes, related information and data on payable health-care services, treatments, procedures, tests and laboratories and said related accounting, utilizations, expenses, disbursements, payments, redistributions, adjustments, credits, account payables, receivables, collectibles and unpaid charges of services, revenues and earnings are also generated, displayed and used, appropriately, by individual patients and individual physicians.

In said instances, the present invention further provides a process of retrieving, displaying and using said processes and said interactive words and terms representing individual diagnoses which are made interactive with patients and physicians to generate, display and use logics on or relating to said information and data on health, health care and health care services and said dispensations and utilizations of health care and health-care services by physicians and patients, respectively, stored and compiled in the database or databases in said SQL server and in the memory or memories of said computer server or servers to patients and physicians. Said logics also encompass scientific and medical information and data, journals and literatures, discussions, arguments on or relating to said diagnoses and related treatments, surgeries and laboratories and testings, cost-effectiveness, cost effects, revenue effects, medical and legal issues, comments and warnings. Said information and data and journals and literatures, discussions, arguments and related are generated, stored and related in the memories of said computer server or servers.

The present invention enhances or ensures the fidelity of said information and data being used and processed by said processes to produce accurate information and data outcomes and minimize errors for physicians, patients and health-care buyers by using said system and processes described supra and also effecting the retrievals and uses by physicians of said numerous interactive pop-ups and/or drop-down lists and/or menus and interactive graphics comprising said information and data and said words and terms in the database or databases in and manage by said SQL server to achieve the goals and objectives of the present invention. At least Java Script and AJAX are used to support interactive pop-ups and/or drop-down lists and/or menus and interactive graphics.

It has been described in said pending patent applications and the present invention, said data and information are words, terms, word and term headers and topics and subjects as shown supra such as, but not limited to, Evaluation, Chief Complaints, Review of Systems, Diagnoses, Differential Diagnoses, Physical Examinations, Medications, Treatments, Surgeries, etc., phrases, synonyms, codes, numbers, sentences, texts and graphic, etc. used and use by physicians in all—approximately 85—medical and surgical specialties and practices to describe, generate, document and communicate information and data on diagnoses, diseases, illnesses, disorders, health, health-care and health-care services provided to patients by physicians of different and diverse medical and surgical specialties or practices.

It is understood that further to supra, in addition to said words, terms, phrases and sentences stored and related in the database or databases in and manage by said SQL server, digits and alphanumerics can and are also used—albeit far less commonly than the uses and applications of said words, terms, phrases and sentences—in said information and data on health, health-care and health-care services provided to patients generated by physicians and said data on health-care services relate to same or equivalent data on health-care services and relating monetary values representing prices or monetary values of said services in the database or databases. In this setting, it is understood that the above can be and is adapted to incorporate this variation present in said data and information.

It is understood that the present invention is also able to convert said words, terms, phrases and sentences into corresponding digits and further modify or adapt the database or databases to comprise of digits within the spirit and scope of the claims of the present invention.

The method, processes, system, protocols, matters, products, functions and related and derivatives of the present invention are implemented and effected by an innovative computer software and program invented and developed by the present patent applicant which were filed with and are stored in the Library of Congress in Washington, D.C. The present invention uses also the commercially available computer software (plural), programs and computer languages such as, but not limited to, those made and sold by Microsoft Corporation such as, but not limited to, Microsoft Windows Server, SQL server such as, but not limited to Microsoft SQL Server, MySQL and the like, Web browsers such as, but not limited to, Windows Internet Explorer, Mozilla Firefox, Apple Safari, Google Chrome, Opera, and the like, Web server, Apache, Microsoft IIS, Visual Studio and .Net, Microsoft software including Notepad, Wordpad and .txt programs and their derivatives and the like and related and their database, databases and derivatives, other computer corporations' and companies' programs, languages, codes and databases and their derivatives which are commonly and routinely used by computer engineers and programmers such as, but not limited to, PHP, PERL, C languages, such as, but not limited to, C, C+, C++, C#, JAVA, Java Script, AJAX, HTML, XHTML and the like and related and their derivatives. Other security software are such as, but not limited to, encryption-decryption of the information and data infra and their derivatives and products, processes and software, Firewall, anti-viral and related, Secure Sockets Layer (SSL) or Transport Layer Security (TLS) and related and the like and their derivatives. Information and data on diagnoses of diseases and disorders and health, health-care and health-care services on and relating to said diagnoses, diseases and disorders are generated by said physicians using computers and/or mobile communication devices, such as, but not limited to, mobile cordless phones and said information and data are submitted by physicians via the Internet to the database or databases.

The standard commercial software applications and hardware and equipment being used are the Hypertext Transfer Protocol (HTTP), Hypertext Transfer Protocol Safe (HTTPS), File Transfer Protocol (FTP) and Uniform Resource Identifier (URI) and Transmission Control/Internet Protocol (TCP/IP) networks and the like or equivalence such as, but not limited to, the Internet or World Wide Web are implemented and deployed per standard industrial practices and use hardware and equipment such as, but not limited to, computer servers and computers such as Hewlett-Packard (HP) and International Business Machines (IBM) servers, HP and Dell computers, Cisco routers and related, and various equipment including modems sold, lease, own and operate by cable companies such as, but not limited to, Time Warner and Optimum Online in New York, etc. Currently, HP ProLiant ML350 and ML110 Generation 4p Servers—see www.hp.com for details of the server hardware and internal design—and similar Dell server—see www.dell.com for details of the server hardware and internal design—used by the present patent applicant as the hardware wherein the computer programs and software (plural) mentioned herein operate. It is obvious and known that with more extensive operations and requirements, server blades and various hardware and equipment configurations, virtual servers such as those sold by VMware, HP and IBM, and the touch-enabled viewing screens or touchscreens—single or multiple—are manufactured and sold by many corporations such as, but not limited to, HP, Dell and IBM and their derivatives being used by many large American corporations can and will be used to implement the present invention.

Consequent to the incorporations of said data and information using computer programs, software mentioned herein and the like, the products of said incorporations are stored in and retrieved from database or databases to be displayed on the viewing screens and comprehensible and use by patients and physicians.

Said processes, events, outcomes and products are enabled, effected and/or facilitated by and in a network or networks of computers, portable and/or wireless communication devices and operating and functioning computer servers comprising a plurality of processors, memories, server operating system, a networking capability comprising a Web browser, Web server, SQL server, computer scripting language programs and innovative computer programs and software communicating with and commanding said SQL server and database or databases.

It is understood that—by laws and medical ethics—each patient can only access and use such as, but not limited to, add and edit, and view his or her health and health-care information and data and, under the same setting, only physicians authorized by said patient are permitted and allow access to said patient's confidential health and health-care information and data infra. Corollary, each patient can view and feedback on information and data on health-care and health-care services and related payments, disbursements, credits, debits, deductions, disbursements, refunds or reimbursements and balances. Similarly, each physician can also view and feedback on the information and data on healthcare and health-care services and related payments, compensations and/or credits and year-to-date and total payments to his or her account. Similarly, each company or corporation or health-care buyer can also view and feedback on the disbursements, deductions and balances data pertinent to the company's, corporation's or health-care buyer's account.

It is understood that patients are or can be health-care consumers and health-care buyers and employers, companies, corporations and governments are health-care buyers although employers are or can be patients. Health-care providers are physicians and other people who provided health and health-related services to people. Furthermore, the present invention also encompasses and enables families such as, children and minors, and dependents—by said definition—to achieve the goals and objects of the present invention operating in the U.S.A. and other nations. For example, in one of numerous preferred embodiments of the present invention, a head of a household such as, but not limited to, a father who works for a company—both may contribute funds or pay into the funds to pay for said health-care services—can have his spouse, children, dependent and/or dependents to access and use said funds to pay for said health-care services use by them. Furthermore, in yet one of numerous preferred embodiments of the present invention, said spouse, children, dependent and/or dependents can also contribute and/or add his, her and/or their own money and resources to said funds or, along with said funds, also use his, her and/or their owns and/or respective employer's or employers' money and resources, etc. Thus, in the preferred embodiments of the present invention, the objectives and goals of the present invention are achieved for all parties.

It is understood that the terms health-care, health care and healthcare have the same meaning and application and that the terms computer server and server have the same meaning and application. Also, it is understood that the term software is used herein as singular and pleural.

It is understood that health-care resources, credits, funds, payments, disbursements, reimbursements, totals, balances, etc. used herein are such as, but not limited to, dollars and cents and other foreign currencies and instruments of payment.

It is to be understood that said preferred embodiments and examples apply to physicians and information and data on diseases and disorders in about 85 medical and surgical specialties or practices.

It is to be understood that the present invention comprising method, processes, system, protocols, matters, products, functions and related and derivatives—implemented, effect and operate by said innovative computer software and program operating in said computer server or servers—are far more complex, extensive, intelligent, versatile and more than two dimensional and more versatilely, logically and relationally organized, arranged and presented than said brief and simple representations herein.

Although pooled or compiled information and data described herein retrieved and generated from said information and data in the database or databases in and manage by said SQL server are available to patients and physicians having access to said pooled or compiled information and data designed and effected by the innovative computer programs and software of the present applicant in compliance with the laws and ethics, it is understood that—by laws and ethics applicable to the present invention and said descriptions of the preferred embodiments and people—health, health-care and health-care service data and information on individual patients belongs or relates to said individual patients so that each patient can only access, view and use see his or her own said information and data as require and permit by laws such as, but not limited to HIPPA and are generated and safeguarded by physicians who are authorized by same to safeguard and to access and view said data and information.

Although various preferred embodiments of the present invention have been described, it is evident that the words and terms representing diagnoses in the specification and claims can, may and/or will include, encompass and/or apply to other medical and surgical words, terms and/or phrases such as, but not limited to, evaluations, surgical procedures, surgeries, medical treatments and surgical treatments, laboratories, tests, medications, etc. to achieve the goals and objectives of the present invention without departing from the spirit and the scope of the claims of the present invention.

Having described some of the preferred embodiments of the present invention, said embodiments of the present invention can be extended to embody and provide a platform for a barter system or an exchange as a means for paying or compensating physicians by health-care consumers or health-care buyers wherein health and health-care resources produce by, derived from or of physicians can be exchanged or bartered with non-health and non-health-care goods and services produced, performed by, derived from or of patients and health-care buyers. This is useful for people and health-care buyers with either no or limited financial resources but have unused, excess or over-produced goods and services and/or other resources such as, but not limited to, skills, trades, items or matters of value.

Although various preferred embodiments of the present invention have been described, it will be appreciated by those skilled in the art that adaptations and variations may be made without departing from the spirit and the scope of the claims of the present invention.

1. A system for patterning and managing the dispensations of health care and health-care services to patients of or by physicians and for patterning and managing the utilizations of health care and health-care services of or by patients and for managing physicians' compensations for health care and health-care services provided to patients and for managing patients' and health-care buyers' health-care funds and disbursements in a network or networks of computers, portable and/or wireless communication devices and operating and functioning computer servers comprising a plurality of processors, memories, server operating system, a networking capability comprising a Web browser, Web server, SQL server, computer scripting language programs and innovative computer programs and software communicating with and commanding said SQL server and database or databases wherein words and terms which are integral components of health, health-care and health-care-service information and data on or relating to diseases and disorders and patients and are used by physicians of all and diverse medical and surgical practices or specialties for and in the communications of said information and data among and between physicians and between physicians and patients and are continually and perpetually generated and submitted by physicians and patients and are stored, related, compiled in the database or databases in and manage by said SQL server wherein words and terms on health care and health-care services and relating prices, monetary values or costs generated, submitted, stored, related and compiled or pooled in the database or databases in and manage by said SQL server wherein information and data representing health-care accounts comprising monetary values, funds, revenues, earnings, disbursements or expenses of physicians, patients and health-care buyers are generated, stored, related in the database or databases in and managed in said SQL server wherein words and terms same as, similar to and/or equivalent to said words and terms and relating said monetary values, funds, revenues, earnings, disbursements or expenses generated, related and stored in the database or databases in and manage by said SQL server, wherein generated and/or submitted information and data are scanned and checked for redundant repeats, doubles or similars and/or errors which can be corrected by physicians and/or patients, wherein information and data on health, health care and health-care services and relating monetary values, funds, revenues, earnings, disbursements or expenses are generated, submitted, stored, related and compiled in the database or databases in and manage by said SQL server wherein information and data representing health-care accounts comprising monetary values or funds of individual physicians and patients and payments, distributions, redistributions of payments, disputes, appeals, credits, debits, refunds, balances, revenues and earnings of individual physicians and debits, credits, refunds, deductions and/or disbursements from patients' and/or health-care buyers' deposits and/or funds corresponding to said payments or compensations to said physicians by and/or on the behalf of said patients and by and/or on the behalf of said health-care buyers generated, stored, related and managed in said SQL server wherein said words and terms for effecting the generations, managements and maintenances of individual payments, distributions, redistributions of payments, disputes, appeals, credits, debits, refunds, balances, revenues and earnings of individual physicians and debits, credits, refunds, deductions and/or disbursements from patients' and/or health-care buyers' deposits and/or funds corresponding to said payments or compensations to said physicians by and/or on the behalf of said patients and by and/or on the behalf of said health-care buyers in the database or databases in and manage by said SQL server wherein said words and terms for effecting the generations, managements and maintenances of higher or lower adjustments to individual payments or distributions and redistributions of payments pertaining or relating to diagnoses and relating procedures and treatments, wherein the resultant information and data outcomes and products on or relating to funds, payments, distributions, redistributions, adjustments, disputes, appeals, credits, debits, refunds, balances, revenues and earnings are generated, stored, related in the database or databases in and managed in said SQL server wherein words and terms for informing physicians of erroneous words and terms generated and submitted by said physicians, words and terms for changing, correcting or editing erroneous words and terms by said physicians, words and terms for enabling patients to dispute payments, to hold payments in abeyance, for enabling physicians to respond to patients' disputes and for implementing payments to physicians, wherein interactive medical words and terms representing diagnoses on or relating to individual patients to and are interactive with physicians and patients for enabling physicians and patients to access, retrieve and display individual arrays or series of information and data on individual information and data on related health, health care and health-care services of individual patients provided by physicians and related payments, distributions, adjustments, disbursements, disputes, appeals, credits, refunds and balances and individual arrays or series of related pooled or compiled information and data on related health, health-care and health-care services provided to patients by physicians and related payments, distributions, adjustments, disbursements, disputes, appeals, credits, refunds and balances in the database or databases in and manage by said SQL server by patients and/or physicians, wherein said information and data and outcomes and products are perpetually generated, submitted, expanded, updated, improved, related and viewed and used by physicians and patients using computers, portable and/or wireless communication devices in said network or networks, wherein interactive panels, tools and functions for physicians and patients to generate and submit said information and data to the database or databases in said computer server or servers are located, positioned and functioning—wherever feasible, achievable, workable or practicable—in the right half or area of the viewing screens including touch-enabled screens or touchscreens of physicians' and/or patients' said computers, portable and/or wireless communication devices where said interactive functions, panels and tools are organized or ordered to optimize the efficient visualizations and locations of said interactive functions, panels and tools by physicians and patients and to optimize and expedite the productions of the outcomes of physicians' and patients' interactions, wherein said information and data, outcomes and products are effected and retrieved for displays to and uses by physicians and patients by said computer scripting language programs and innovative computer programs and software for effecting and affecting the interactions and sharing of information and data and logics on health, health care and health-care services by, of and among physicians and patients, for effecting and affecting the patterning of physicians' dispensations of health care and health-care services to patients and the patterning of patients' utilizations of health care and health-care services, for improving the practices of medicine and surgery of and by physicians, for improving the utilizations of health care and health-care services by patients and for improving the health care system comprises:
said computer scripting language programs and innovative computer programs and software for communicating with and commanding SQL server and database or databases;
said computer scripting language programs and innovative computer programs and software for generating, storing, relating and managing said information and data in said databases in and manage by said SQL server;
said computer scripting languages and innovative computer programs and software for retrieving and displaying on Web pages said information and data in said database or databases in and manage by said SQL server;
a Web browser coupled to said innovative computer programs and software and said SQL server and databases in said computer server or servers;
a SQL database or SQL databases comprising words and terms which are integral components of health, health-care and health-care-service information and data on or relating to diseases and disorders and patients and are used by physicians of all and diverse medical and surgical practices or specialties for and in the communications of said information and data among and between physicians and between physicians and patients are generated, submitted, stored, related, compiled in the database or databases in and manage by said SQL server;
interactive medical words and terms representing diagnoses on or relating to individual patients which are interactive with physicians and patients for accessing information and data and information and data products and outcomes on and relating to physicians and patients in the database or databases in and manage by said SQL server;
a SQL database or SQL databases comprising information and data on health, health care and health-care services provided to patients by physicians generated and submitted by physicians and patients and stored, related and compiled in the database or databases in and manage by said SQL server;
a SQL database or SQL databases comprising information and data on health, health care and health-care services and relating prices, monetary values or costs generated, submitted, stored, related and compiled in the database or databases in and manage by said SQL server;
a SQL database or SQL databases comprising information and data representing health-care accounts comprising monetary values or funds of physicians, patients and health-care buyers generated, stored, related, compiled in the database or databases in and managed by said SQL server;
a SQL database or SQL databases comprising health, health-care and health-care service information and data including said words and terms generated, relate and store in the database or databases in and manage by said SQL server in said computer server or servers available to said physicians' uses;
a SQL database or SQL databases comprising health, health-care and health-care service information and data including said words and terms generate by physicians and submit, store and relate in the database or databases in and manage by said SQL server, words and terms which are same as, similar to and/or equivalence of said words and terms and relating monetary values representing prices, monetary values or costs of said health-care and health-care services generated, relate and store in the database or databases in and manage by said SQL server in said computer server or servers, said words and terms and relations of said words, terms and relating prices, monetary values or costs in the database or databases in and manage in said SQL server;
a SQL database or SQL databases comprising matched words and terms in the database or databases in and manage by said SQL server in said computer server or servers;
a SQL database or SQL databases comprising matched words and terms and relating monetary values representing prices, monetary values or costs of said health-care and health-care services in the database or databases in and manage by said SQL server in said computer server or servers;
a SQL database or SQL databases comprising erroneous words and terms generate and use by physicians, changes, corrections or editions of said erroneous words and terms in and manage by said SQL server in said computer server or serves;
a SQL database or SQL databases comprising information and accounting on patients' disputes on payments, withholding of payments, physicians' responses to patients' disputes and implementations of payments to physicians in and manage by said SQL server in said computer server or serves;
a SQL database or SQL databases comprising information and data and accounting on payments or compensations for health-care and health-care services provided to patients by physicians;
a SQL database or SQL databases comprising information and data on payments, adjustments to individual payments, distributions, redistributions of payments, disputes, appeals, credits, debits, refunds, balances, revenues and earnings of individual physicians;
a SQL database or SQL databases comprising information and data deposits of funds, debits, credits, refunds, deductions and/or disbursements from patients' and/or health-care buyers' deposits and/or funds corresponding to said payments or compensations to said physicians by and/or on the behalf of said patients and by and/or on the behalf of said health-care buyers in the database or databases in and manage by said SQL server;
words and terms representing diagnoses on or relating to individual patients and are interactive with physicians and patients generated, submitted to, store and relate in said database or databases in said SQL server;
individual arrays or series of information and data on individual information and data on related health, health care and health-care services of individual patients provided by physicians in the database or databases in and manage by said SQL server;
individual arrays or series of information and data on individual information and data on related health, health care and health-care services of individual patients provided by physicians and related payments, distributions, redistributions, adjustments, disbursements, disputes, appeals, credits, refunds and balances in the database or databases in and manage by said SQL server;
individual arrays or series of related pooled or compiled information and data on related health, health-care and health-care services provided to patients by physicians in the database or databases in and manage by said SQL server by patients and/or physicians;
a SQL database or SQL databases comprising said resultant information and data outcomes and products; and
at least a Web browser for retrieving and displaying said information and data in said database or databases in said SQL server in said computer server or servers which are viewed on Web pages, used and expanded by patients and physicians using said computers, portable and/or wireless communication devices to access said computer server or servers in said network or networks via the Internet.

2. In a system for patterning and managing the dispensations of health care and health-care services to patients of or by physicians and for patterning and managing the utilizations of health care and health-care services of or by patients and for managing physicians' compensations for health care and health-care services provided to patients and for managing patients' and health-care buyers' health-care funds and disbursements, a method for patterning and managing the dispensations of health care and health-care services to patients of or by physicians and patterning and managing the utilizations of health care and health-care services of or by patients and for managing physicians' compensations for health care and health-care services provided to patients and for managing patients' and health-care buyers' health-care funds and disbursements in a network or networks of computers, portable and/or wireless communication devices and operating and functioning computer servers comprising a plurality of processors, memories, server operating system, a networking capability comprising a Web browser, Web server, SQL server, computer scripting language programs and innovative computer programs and software communicating with and commanding said SQL server using words and terms which are integral components of health, health-care and health-care-service information and data on or relating to diseases and disorders and patients and are used by physicians of all and diverse medical and surgical practices or specialties for and in the communications of said information and data among and between physicians and between physicians and patients and are generated, submitted, stored, related, compiled or pooled in the database or databases in and manage by said SQL server in said computer server or servers, using generated and submitted information and data including said words and terms on or relating to health, health care and health-care services which are stored, related, compiled or pooled in the database or databases in and manage by said SQL server wherein said information and data including said words and terms are available to physicians' uses and/or are generated and submitted by physicians to generate and submit said information and data including said words and terms to the database or databases in said SQL server, using information and data including said words and terms on health, health care and health-care services provided to patients by physicians which are generated and submitted by physicians which are scanned and checked for redundant repeats, doubles or similars and/or errors wherein errors can be corrected by physicians and/or patients and are stored, related and compiled or pooled in the database or databases in and manage by said SQL server, using words and terms and information and data on health, health care and health-care services and relating prices, monetary values or costs of said services generated, submitted, stored, related and compiled in the database or databases in and manage by said SQL server, using words and terms which are same as, similar to and/or equivalence of said words and terms and relating monetary values representing prices, monetary values or costs of said health-care and health-care services generated, relate and store in the database or databases in and manage by said SQL server, using said words and terms and relations of said words, terms and relating prices, monetary values or costs to generate relating payments, distributions, redistributions of payments, disputes, appeals, credits, debits, refunds, balances, revenues and earnings of individual physicians and debits, credits, refunds, deductions and/or disbursements from patients' and/or health-care buyers' deposits and/or funds in the database or databases in and manage in said SQL server, using information and data representing health-care accounts comprising monetary values or funds of individual physicians and patients and payments, distributions, redistributions of payments, disputes, appeals, credits, debits, refunds, balances, revenues and earnings of individual physicians and debits, credits, refunds, deductions and/or disbursements from patients' and/or health-care buyers' deposits and/or funds corresponding to said payments, compensations and/or distributions to said physicians by and/or on the behalf of said patients and by and/or on the behalf of said health-care buyers are generated, stored, related and managed in said SQL server, enabling patients to dispute payments, holding payments in abeyance, enabling physicians to respond to patients' disputes, implementing payments to physicians, producing, retrieving, displaying, showing and effecting the uses of said information and data including said words and terms by physicians and patients, producing, retrieving, displaying and effecting the uses of the interactive medical words and terms representing diagnoses on or relating to health, health care and health-care services on individual patients to and interactive with physicians and patients to access, display, manage, use and expand information and data on and relating to health, health-care and health-cares services, automatically generating or creating and managing resultant information and data outcomes and products on or relating to payments or compensations for health-care and health-care services provided to patients by physicians and to retrieve and display said resultant information and data outcomes and products on and relating to payments or compensations for health-care and health-care services and on the deposits of funds and debits, deductions and/or disbursements from patients' and/or health-care buyers' deposits and/or funds corresponding to said payments or compensations to said physicians by and/or on the behalf of said patients and by and/or on the behalf of said health-care buyers in the database or databases in and manage by said SQL server in said computer server or servers and using said words and terms to inform physicians of erroneous words and terms generated and submitted by said physicians, to change, correct or edit erroneous words and terms by said physicians, effecting the automatic generations, managements and maintenances of individual payments, distributions, redistributions of payments, disputes, appeals, credits, debits, refunds, balances, revenues and earnings of individual physicians and debits, credits, refunds, deductions and/or disbursements from patients' and/or health-care buyers' deposits and/or funds corresponding to said payments or compensations to said physicians by and/or on the behalf of said patients and by and/or on the behalf of said health-care buyers in the database or databases in and manage by said SQL server, effecting the automatic generations, managements and maintenances of higher or lower adjustments to individual payments, distributions or redistributions of payments pertaining or relating to diagnoses and relating procedures and treatments wherein the resultant information and data outcomes and products on or relating to funds, payments, distributions, redistributions, adjustments, disputes, appeals, credits, debits, refunds, balances, revenues and earnings are generated, stored, related in the database or databases in and managed in said SQL server, using said words and terms to generate, retrieve, display and use individual arrays or series of information and data on individual related health, health-care and health-care services and related funds, payments, distributions, redistributions, adjustments, disputes, appeals, credits, debits, refunds, balances, revenues and earnings in the database or databases in and manage by said SQL server, using said words and terms to generate, retrieve, display and use individual arrays or series of related pooled and compiled information and data on individual health, health care and health-care services provided to patients and related health-care and health-care services and related funds, payments, distributions, redistributions, adjustments, disputes, appeals, credits, debits, refunds, balances, revenues and earnings of or related to physicians and patients, locating or positioning the interactive panels, tools and functions and communications to physicians and patients—wherever feasible, achievable, workable or practicable—in the right half or area of said viewing screens including touch-enabled screens or touchscreens of physicians' and/or patients' said computers, portable and/or wireless communication devices where said interactive functions, panels and tools are organized or ordered to optimize the efficient visualizations and locations of said interactive functions, panels and tools by physicians and patients and to optimize and expedite the retrievals, displays, uses of the information and data and the generations and productions of the products and outcomes of said processes and of physicians' and patients' interactions with the displayed information and data and described herein, and enabling physicians and patients to use computers and/or portable electronic communication devices in a network or networks of computers, portable electronic communication devices and said computer server or servers to transmit said information and data to and to retrieve, view, use, manage and expand said information and data in the database or databases in said SQL server, to effect the control of health-care resources by physicians, patients and health-care buyers, to effect and affect the patterning of physicians' dispensations of health care and health-care services to patients and the patterning of patients' utilizations of health care and health-care services, to effect the interactions and sharing of information and data and logics on health, health care and health-care services by, of and among physicians, patients, and health-care buyers to improve the practices of medicine and surgery of and by physicians, the dispensations and utilizations of health care and health-care services by physicians and patients comprises:
a process of operating a network or networks of operating and functioning computer servers comprising a plurality of processors, memories, server operating system, a networking capability comprising a Web browser, Web server, SQL server, computer scripting language programs and innovative computer programs and software communicating with and commanding said SQL server;
a process of using said computer scripting languages and innovative computer programs and software to communicate with and command said SQL server;
a process of using said computer scripting languages and innovative computer programs and software to generate, expand and manage information and data in the database or databases in and manage by said SQL server;
a process of using computer scripting language programs and innovative computer programs and software to communicate with and command SQL server and database or databases and Web browser;
a process of coupling a Web browser to said innovative computer programs and software and said SQL server and databases in said computer server or servers;
a process of using said computer scripting languages and innovative computer programs and software for retrieving and displaying on Web pages said information and data in said database or databases in and manage by said SQL server;
a process of using a Web browser to retrieve and view said information and data by physicians and/or patients;
a process of patterning and managing the dispensations of health care and health-care services to patients of or by physicians and patterning and managing the utilizations of health care and health-care services of or by patients and of managing physicians' compensations for health care and health-care services provided to patients and for managing patients' and health-care buyers' health-care funds and disbursements;
a process of generating, maintaining, expanding and implementing the database or databases in said SQL server;
a process of relating and compiling the information and data in the database or databases in said SQL server;
a process of using said computer scripting language programs and innovative computer programs and software for generating, storing, relating and managing said information and data in said databases in and manage by said SQL server;
a process of using said computer scripting languages and innovative computer programs and software to generate, relate and manage health, health-care and health-care-service information and data and the health, health-care and health-care-services information and data products and outcomes of the generations, relations, managements and uses of said information and data in the database or databases which are submitted, stored, related, compiled or pooled in said database or databases in and manage by said SQL server;
a process of generating, relating and managing health, health-care and health-care-service information and data and the health, health-care and health-care-service information and data products and outcomes of the generations, relations, managements and uses of said information and data in the database or databases which are submitted, stored, related, compiled or pooled in said database or databases in and manage by said SQL server;
a process of using said computer scripting languages and innovative computer programs and software to generate, relate and manage said information and data and said products and outcomes and to retrieve, display on Web pages, and to effect the views and uses of said information and data and products and outcomes by patients and physicians;
a process of generating, relating, managing and using said information and data and products and outcomes of said processes;
a process of generating, maintaining and expanding information and data and the information and data outcomes and products in the database or databases in and manage by said SQL;
a process of retrieving, displaying and using words and terms which are integral components of health, health-care and health-care-service information and data on or relating to diseases and disorders and patients and are used by physicians of all and diverse medical and surgical practices or specialties for and in the communications of said information and data among and between physicians and between physicians and patients are generated, submitted, stored, related, compiled in the database or databases in and manage by said SQL server;
a process of retrieving, displaying and using said words and terms to generate, manage, relate, display, use, expand and improve information and data on health, health-care and health-care-services;
a process of retrieving, displaying and using said words and terms to generate, manage, relate, display, use, expand and improve information and data on health, health-care and health-care-services and on or relating health-care funds, payments, distributions, redistributions, adjustments, disputes, appeals, credits, debits, refunds, balances, revenues and earnings of physicians, patients and health-care buyers;
a process of retrieving and displaying and using said interactive medical words and terms representing diagnoses on or relating to individual patients to and interactive with physicians and patients to retrieve, display, use, expand, improve and manage said information and data on health, health-care and health-care-services in the database or databases in and manage by said SQL server;
a process of retrieving and displaying and using said interactive medical words and terms representing diagnoses on or relating to individual patients to and interactive with physicians and patients to retrieve, display, use, expand, improve and manage said information and data on health, health-care and health-care-services and on or relating health-care funds, payments, distributions, redistributions, adjustments, disputes, appeals, credits, debits, refunds, balances, revenues and earnings of physicians, patients and health-care buyers;
a process of retrieving, displaying and using information and data on health, health care and health-care services and relating prices, monetary values or costs generated, submitted, stored, related and compiled in the database or databases in and manage by said SQL server;
a process of retrieving, displaying and using information and data on health, health care and health-care services and relating funds, payments, distributions, redistributions, adjustments, disputes, appeals, credits, debits, refunds, balances, revenues and earnings of physicians, patients and health-care buyers generated, stored, related, compiled in the database or databases in and managed by said SQL server;
a process of generating, submitting, storing, relating, compiling and pooling words and terms which are components of health, health-care and health-care-service information and data on or relating to diseases and disorders and patients and are used by physicians of all and diverse medical and surgical practices or specialties for and in the communications of said information and data among and between physicians and between physicians and patients in the database or databases in and manage by said SQL server;
a process of generating, submitting, storing, relating, compiling and pooling information and data including said words and terms on or relating to health, health care and health-care services provided to patients by physicians which are generated and/or used and submitted by physicians and patients in the database or databases in and manage by said SQL server;
a process of generating, submitting and relating words and terms same as, similar to and/or equivalence of said words and terms in the database or databases in said SQL server;
a process of generating, submitting and storing words and terms same as, similar to and/or equivalence of said words and terms and relating monetary values representing prices, monetary values or costs of said health-care and health-care services in the database or databases in said SQL server;
a process of retrieving, displaying and using said words and terms by physicians and patients;
a process of retrieving, viewing and using said words and terms same as, similar to and/or equivalence of said words and terms in the database or databases by physicians and/or patients;
a process of retrieving, displaying and using said words and terms and relating monetary values representing prices, monetary values or costs of said health-care and health-care services in the database or databases in said SQL server;
a process of retrieving, viewing and using said words and terms same as, similar to and/or equivalence of said words and terms and relating monetary values representing prices or monetary values of said health-care and health-care services generated, related and stored in the database or databases in said SQL server;
a process of applying said innovative computer programs and software operating and functioning in said computer server or servers to scan said information and data and words and terms;
a process of applying said innovative computer programs and software operating and functioning in said computer server or servers to select matches of said words and terms;
a process of applying said innovative computer programs and software operating and functioning in said computer server or servers to select matches of said words and terms and relating prices, monetary values or costs of said health-care and health-care services in the database or databases in said SQL server in said computer server or servers;
a process of scanning words and terms which are integral components of first health, health-care and health-care-service information and data on or relating to individual patients generated and submitted by said physicians to the database or databases in said SQL server in said computer server or servers and words and terms same, similar and/or equivalent to said words and terms in the database or databases in said SQL server in said computer server or servers;
a process of matching words and terms which are integral components of health, health-care and health-care-service information and data on or relating to individual patients generated and submitted by said physicians to the database or databases in said SQL server in said computer server or servers with words and terms same, similar and/or equivalent to said words and terms in the database or databases in said SQL server in said computer server or servers;
a process of scanning words and terms generated and/or used and submitted by physicians;
a process of scanning words and terms used by physicians retrieving said words and terms from the database or databases in said SQL server and words and terms same, similar and/or equivalence of said words and terms and relating monetary values, prices or costs in the database or databases in said SQL server in said computer server or servers;
a process of scanning words and terms used and submitted by physicians for redundant repeats, doubles or similars and/or errors;
a process of matching words and terms generated and submitted by physicians and words and terms same, similar and/or equivalence of said words and terms in said SQL server;
a process of matching words and terms generated and submitted by physicians and words and terms same, similar and/or equivalence of said words and terms and relating monetary values, prices or costs which are stored and managed in said SQL server;
a process of matching words and terms used and submitted by physicians and words and terms same, similar and/or equivalence of said words and terms and relating monetary values, prices or costs which are stored and managed in said SQL server;
a process of entering, storing and relating the products and outcomes of said scans of words and terms in the database or databases in and manage by said SQL server;
a process of entering, storing and relating the information and data outcomes and products of said matches of words and terms and selected relating prices, monetary values or costs in the database or databases in said SQL server;
a process of generating and storing said words and terms same, similar to and/or equivalence of said words and terms and relating monetary values, prices or costs generated, related, entered into and store in the database or databases in said SQL server;
a process of generating the information and data outcomes and products of matching said words and terms generated and submitted by physicians and said words and terms and relating monetary values, prices or costs which are stored and managed in said SQL server;
a process of generating the information and data outcomes and products of relating said words and terms used by physicians by retrieving said words and terms from the database or databases in said SQL server and said words and terms same, similar and/or equivalence of said words and terms and relating monetary values, prices or costs which are stored and managed in said SQL server;
a process of generating the resultant information and data outcomes and products of matching said words and terms generated and/or used by physicians with words and terms same, similar and/or equivalence of said words and terms and relating monetary values, prices or costs which are stored and managed in said SQL;
a process of storing and managing said resultant information and data outcomes and products of said matching said words and terms and relating monetary values, prices or costs in said SQL server;
a process of generating and maintaining accounts of physicians comprising information and data on payments, compensations, refunds and debits in the database or databases in said SQL server;
a process of using said words and terms to effect the generations, managements and maintenances of accounts of physicians comprising information and data on distributions, adjustments, redistributions, refunds, credits and debits in the database or databases in said SQL server;
a process of generating accounts of patients comprising deposits, debits, disbursements, refunds and credits in the database or databases in said SQL server;
a process of generating accounts of health-care buyers comprising deposits, debits, disbursements, refunds and credits in the database or databases in said SQL server;
a process of managing, accounting and displaying the deposits of and debits, deductions and/or disbursements from patients' and/or health-care buyers' deposits and/or funds corresponding to said payments or compensations to said physicians by and/or on the behalf of said patients and by and/or on the behalf of said health-care buyers in said SQL server;
a process of using said words and terms to inform and display for physicians said erroneous words and terms in said computer server or servers generate and submit by physicians;
a process of effecting changes, corrections and editions of said erroneous words and terms to correct words and terms in said computer server or servers by physicians to corrected words and terms;
a process of disputing payments and disbursements in said computer server or servers by patients;
a process of withholding payments to physicians in said computer server or servers by patients as the consequences of said patients' disputes;
a process of responding to patients' disputes and withholding of payments by physicians;
a process of implementing payments to physicians in said computer server or servers as the consequences of said physicians' responses to said patients' disputes;
a process of inserting said words and terms and relating monetary values into said physicians' accounts in the database or databases in said SQL server;
a process of inserting said words and terms and relating monetary values into said patients' accounts in the database or databases in said SQL server in said computer server or servers;
a process of relating said data the credits representing payments credited to the physicians' accounts for the health-care services provided to patients by said physicians and said data on the debits, deductions or disbursements of funds representing payments for said services to said physicians from said patients' accounts in the database or databases in said SQL server in said computer server or servers;
a process of relating said data the credits representing payments credited to the physicians' accounts for the health-care services provided to patients by said physicians and said data on the debits, deductions or disbursements of funds representing payments for said services to said physicians from said health-care buyers' accounts in in the database or databases in said SQL server in said computer server or servers;
a process of displaying said information and data on health-care and health-care services and related payments or compensations, debits, refunds, revenues and earnings to said physicians;
a process of displaying said information and data on health-care and health-care services and related deposits, debits, disbursements, refunds, credits and balances to patients;
a process of displaying data on deposits, debits or disbursements and balances to health-care buyers;
a process of correcting erroneous or inaccurate said information and data by physicians;
a process of correcting erroneous or inaccurate said information and data by physicians;
a process of feedbacks on said outcomes and/or products of said processes between said physicians and patients;
a process of managing, organizing and relating said information and data and said resultant information and data outcomes and products of said processes in the database or databases in said SQL server in said computer server or servers;
a process of viewing said information and data on payments, compensations, computations and accounting by physicians and patients;
a process of retrieving and displaying and using said individual arrays or series of said information and data on or relating to health, health-care, health-care services in the database or databases in and manage by said SQL server by physicians and patients;
a process of retrieving and displaying and using said individual arrays or series of information and data on or relating to health, health-care, health-care services and related funds, payments, distributions, redistributions, adjustments, disputes, appeals, credits, debits, refunds, balances, revenues and earnings in the database or databases in and manage by said SQL server by physicians and/or patients;
a process of using words and terms to retrieve, display and use individual arrays or series of said information and data on or relating to health, health-care, health-care services and related funds, payments, distributions, redistributions, adjustments, disputes, appeals, credits, debits, refunds, balances, revenues and earnings in the database or databases in and manage by said SQL server by physicians and/or patients;
a process of using interactive words and terms to retrieve, display and use individual arrays or series of information and data on or relating to health, health-care, health-care services and related funds, payments, distributions, redistributions, adjustments, disputes, appeals, credits, debits, refunds, balances, revenues and earnings in the database or databases in and manage by said SQL server by physicians and/or patients;
a process of retrieving, displaying and using individual arrays or series of related pooled or compiled information and data on or relating to health, health-care, health-care services in the database or databases in and manage by said SQL server by physicians and patients;
a process of retrieving, displaying and using individual arrays or series of related pooled or compiled information and data on or relating to health, health-care, health-care services and related funds, payments, distributions, redistributions, adjustments, disputes, appeals, credits, debits, refunds, balances, revenues and earnings in the database or databases in and manage by said SQL server by physicians and/or patients;
a process of using words and terms to retrieve, display and use individual arrays or series of related pooled or compiled information and data on or relating to health, health-care, health-care services and related funds, payments, distributions, redistributions, adjustments, disputes, appeals, credits, debits, refunds, balances, revenues and earnings in the database or databases in and manage by said SQL server by physicians and/or patients;
a process of using interactive words and terms to retrieve, display and use individual arrays or series of related pooled or compiled information and data on or relating to health, health-care, health-care services and related funds, payments, distributions, redistributions, adjustments, disputes, appeals, credits, debits, refunds, balances, revenues and earnings in the database or databases in and manage by said SQL server by physicians and/or patients;
a process of presenting logics on the dispensations and utilizations of health care and health-care services by physicians and patients stored and compiled in the database or databases in said SQL server and in the memory or memories of said computer server or servers to patients and physicians;
a process of using words and terms to retrieve and display logics on the dispensations and utilizations of health care and health-care services by physicians and patients stored and compiled in the database or databases in said SQL server and in the memory or memories of said computer server or servers to patients and physicians;
a process of using interactive words and terms to retrieve and display logics on the dispensations and utilizations of health care and health-care services by physicians and patients stored and compiled in the database or databases in said SQL server and in the memory or memories of said computer server or servers to patients and physicians;
a process of presenting supporting scientific and medical information and data, journals and literatures, discussions, arguments on or relating to said diagnoses and related treatments, surgeries and laboratories and testings, cost-effectiveness, cost effects, revenue effects, medical and legal issues, comments and warnings to patients and physicians;
a process of using words and terms to retrieve and display scientific and medical information and data, journals and literatures, discussions, arguments on or relating to said diagnoses and related treatments, surgeries and laboratories and testings, cost-effectiveness, cost effects, revenue effects, medical and legal issues, comments and warnings to patients and physicians;
a process of using interactive words and terms to retrieve and display scientific and medical information and data, journals and literatures, discussions, arguments on or relating to said diagnoses and related treatments, surgeries and laboratories and testings, cost-effectiveness, cost effects, revenue effects, medical and legal issues, comments and warnings to patients and physicians;
a process of relating said information and data and said information and data outcomes and products of said matches of words and terms and selected relating prices, monetary values or costs in the database or databases in said SQL server in said computer server or servers;
a process of operating and maintaining said operating and functioning computer server or servers wherein a process of implementing said computer programs and software and said networking capability, innovative computer programs and software effects the accesses, viewing and uses of said information and data and resultant information and data outcomes and products by physicians, patients and health-care buyers using computers, portable electronic communication devices via the Internet;
a process of retrieving, displaying and effecting the viewing and uses of said information and data and products and outcomes by patients and physicians;
a process of using a Web browser to retrieve and display said information and data in said database or databases in said SQL server in said computer server or servers which are viewed on Web pages appearing on said viewing screens, used and expanded by physicians and patients using said computers, portable and/or wireless communication devices to access said computer server or servers in said network or networks via the Internet;
a process of enabling physicians and patients to retrieve, display, view, expand, manage and use said information and data and information and data outcomes and products of said scans and matches of words and terms and selected relating prices, monetary values or costs in the database or databases in said SQL server and said processes;
a process of locating or positioning—wherever feasible, achievable, workable or practicable—interactive functions, panels and tools and information and data health, health-care, health-care services and communications to physicians and patients in the right half or area of said viewing screens including touch-enabled screens or touchscreens; and
a process of using said touch-enabled viewing screens or touchscreens wherein the interactive panels, tools and functions—wherever feasible, achievable, workable or practicable—are located or positioned in the right half or area of said screens.

3. The method for patterning dispensations of health care and health-care services to patients of or by physicians and patterning utilizations of health care and health-care services of or by patients and for managing physicians' dispensations of health care and health-care services and compensations and patients' utilizations of health care and health-care services and health-care fund disbursements according to claim 2 wherein said process of patterning and managing the dispensations of health care and health-care services to patients of or by physicians and patterning and managing the utilizations of health care and health-care services of or by patients and of managing physicians' compensations for health care and health-care services provided to patients and for managing patients' and health-care buyers' health-care funds and disbursements comprises a process of retrieving, displaying on Web pages and using of the interactive medical words and terms representing diagnoses on or relating to individual patients to and interactive with physicians accessing said information and data on health, health-care and health-care services by individual patients and/or physicians.

4. The method for patterning dispensations of health care and health-care services to patients of or by physicians and patterning utilizations of health care and health-care services of or by patients and for managing physicians' dispensations of health care and health-care services and compensations and patients' utilizations of health care and health-care services and health-care fund disbursements according to claim 2 wherein said process of patterning and managing the dispensations of health care and health-care services to patients of or by physicians and patterning and managing the utilizations of health care and health-care services of or by patients and of managing physicians' compensations for health care and health-care services provided to patients and for managing patients' and health-care buyers' health-care funds and disbursements comprises a process of retrieving and displaying on Web pages individual arrays or series of information and data on individual related health of individual patients and related health-care and health-care services provided to individual patients by physicians and related health-care and health-care services and related payments, distributions, adjustments, redistributions, disbursements, disputes, appeals, credits, refunds and balances in the database or databases in and manage by said SQL server by individual patients and/or physicians.

5. The method for patterning dispensations of health care and health-care services to patients of or by physicians and patterning utilizations of health care and health-care services of or by patients and for managing physicians' dispensations of health care and health-care services and compensations and patients' utilizations of health care and health-care services and health-care fund disbursements according to claim 2 wherein said process of patterning and managing the dispensations of health care and health-care services to patients of or by physicians and patterning and managing the utilizations of health care and health-care services of or by patients and of managing physicians' compensations for health care and health-care services provided to patients and for managing patients' and health-care buyers' health-care funds and disbursements comprises a process of retrieving and displaying on Web pages individual arrays or series of related pooled or compiled information and data on individual health, health care and/or health-care services provided to patients by physicians and related health-care and health-care services and related payments, distributions, adjustments, redistributions, disbursements, disputes, appeals, credits, refunds and balances in the database or databases in and manage by said SQL server by patients and/or physicians.

6. The method for patterning dispensations of health care and health-care services to patients of or by physicians and patterning utilizations of health care and health-care services of or by patients and for managing physicians' dispensations of health care and health-care services and compensations and patients' utilizations of health care and health-care services and health-care fund disbursements according to claim 2 wherein said process of patterning and managing the dispensations of health care and health-care services to patients of or by physicians and patterning and managing the utilizations of health care and health-care services of or by patients and of managing physicians' compensations for health care and health-care services provided to patients and for managing patients' and health-care buyers' health-care funds and disbursements comprises a process of retrieving, displaying on Web pages and using individual arrays or series of information and data on individual related health of individual patients and related health-care and health-care services and related payments, distributions, adjustments, redistributions, disbursements, disputes, appeals, credits, refunds and balances by individual patients in the database or databases in and manage by said SQL server by individual patients and/or physicians.

7. The method for patterning dispensations of health care and health-care services to patients of or by physicians and patterning utilizations of health care and health-care services of or by patients and for managing physicians' dispensations of health care and health-care services and compensations and patients' utilizations of health care and health-care services and health-care fund disbursements according to claim 2 wherein said process of patterning and managing the dispensations of health care and health-care services to patients of or by physicians and patterning and managing the utilizations of health care and health-care services of or by patients and of managing physicians' compensations for health care and health-care services provided to patients and for managing patients' and health-care buyers' health-care funds and disbursements comprises a process of retrieving, displaying on Web pages and using said interactive medical words and terms representing diagnoses on or relating to individual patients to and interactive with physicians and patients to access said information and data on health, health-care and health-cares services and results and outcomes of managements of said information and data and to retrieve, display on Web pages and use individual arrays or series of information and data on individual related health of individual patients and related health-care and health-care services provided to individual patients by physicians and related health-care and health-care services and related payments, distributions, adjustments, redistributions, disbursements, disputes, appeals, credits, refunds and balances in the database or databases in and manage by said SQL server by individual patients and/or physicians.

8. The method for patterning dispensations of health care and health-care services to patients of or by physicians and patterning utilizations of health care and health-care services of or by patients and for managing physicians' dispensations of health care and health-care services and compensations and patients' utilizations of health care and health-care services and health-care fund disbursements according to claim 2 wherein said process of patterning and managing the dispensations of health care and health-care services to patients of or by physicians and patterning and managing the utilizations of health care and health-care services of or by patients and of managing physicians' compensations for health care and health-care services provided to patients and for managing patients' and health-care buyers' health-care funds and disbursements comprises a process of retrieving, displaying on Web pages and using said interactive medical words and terms representing diagnoses on or relating to individual patients to and interactive with physicians and patients to access and retrieve said information and data on health, health-care and health-cares services and results and outcomes of managements of said information and data and to retrieve, display on Web pages and data and to retrieve, display on Web pages and use individual arrays or series of information and data on individual related health of individual patients and related health-care and health-care services provided to individual patients by physicians and related health-care and health-care services and related payments, distributions, adjustments, redistributions, disbursements, disputes, appeals, credits, refunds and balances in the database or databases in and manage by said SQL server by individual patients and/or physicians.

9. The method for patterning dispensations of health care and health-care services to patients of or by physicians and patterning utilizations of health care and health-care services of or by patients and for managing physicians' dispensations of health care and health-care services and compensations and patients' utilizations of health care and health-care services and health-care fund disbursements according to claim 2 wherein said process of patterning and managing the dispensations of health care and health-care services to patients of or by physicians and patterning and managing the utilizations of health care and health-care services of or by patients and of managing physicians' compensations for health care and health-care services provided to patients and for managing patients' and health-care buyers' health-care funds and disbursements comprises a process of retrieving, displaying on Web pages and using said interactive medical words and terms representing diagnoses on or relating to individual patients to and interactive with physicians and patients to access said information and data on health, health-care and health-cares services and results and outcomes of managements of said information and data and to retrieve, display on Web pages and to retrieve and display on Web pages and use individual arrays or series of related pooled or compiled information and data on individual health, health care and/or health-care services provided to patients by physicians and related health-care and health-care services and related payments, distributions, adjustments, redistributions, disbursements, disputes, appeals, credits, refunds and balances in the database or databases in and manage by said SQL server by patients and/or physicians.

10. The method for patterning dispensations of health care and health-care services to patients of or by physicians and patterning utilizations of health care and health-care services of or by patients and for managing physicians' dispensations of health care and health-care services and compensations and patients' utilizations of health care and health-care services and health-care fund disbursements according to claim 2 wherein said process of patterning and managing the dispensations of health care and health-care services to patients of or by physicians and patterning and managing the utilizations of health care and health-care services of or by patients and of managing physicians' compensations for health care and health-care services provided to patients and for managing patients' and health-care buyers' health-care funds and disbursements comprises a process of presenting logics and explanations on the dispensations and utilizations of health care and health-care services by physicians and patients, respectively, stored and compiled in the database or databases in said SQL server and in the memory or memories of said computer server or servers to patients and physicians.

11. The method for patterning dispensations of health care and health-care services to patients of or by physicians and patterning utilizations of health care and health-care services of or by patients and for managing physicians' dispensations of health care and health-care services and compensations and patients' utilizations of health care and health-care services and health-care fund disbursements according to claim 2 wherein said process of patterning and managing the dispensations of health care and health-care services to patients of or by physicians and patterning and managing the utilizations of health care and health-care services of or by patients and of managing physicians' compensations for health care and health-care services provided to patients and for managing patients' and health-care buyers' health-care funds and disbursements comprises a process of presenting on Web pages scientific and medical information and data, journals and literatures, discussions, arguments on or relating to said diagnoses and related treatments, surgeries and laboratories and testings, cost-effectiveness, cost effects, revenue effects, medical and legal issues, comments and warnings to patients and physicians.

12. The method for patterning dispensations of health care and health-care services to patients of or by physicians and patterning utilizations of health care and health-care services of or by patients and for managing physicians' dispensations of health care and health-care services and compensations and patients' utilizations of health care and health-care services and health-care fund disbursements according to claim 2 wherein said process of patterning and managing the dispensations of health care and health-care services to patients of or by physicians and patterning and managing the utilizations of health care and health-care services of or by patients and of managing physicians' compensations for health care and health-care services provided to patients and for managing patients' and health-care buyers' health-care funds and disbursements comprises a process of retrieving, displaying on Web pages and using said interactive medical words and terms representing diagnoses on or relating to individual patients to and interactive with physicians and patients to retrieve, display on Web pages and use the logics on the dispensations and utilizations of health care and health-care services by physicians and patients, respectively, stored and compiled in the database or databases in said SQL server and in the memory or memories of said computer server or servers by patients and/or physicians.

13. The method for patterning dispensations of health care and health-care services to patients of or by physicians and patterning utilizations of health care and health-care services of or by patients and for managing physicians' dispensations of health care and health-care services and compensations and patients' utilizations of health care and health-care services and health-care fund disbursements according to claim 2 wherein said process of using said words and terms to effect the generations, managements and maintenances of accounts of physicians comprising information and data on distributions, adjustments, redistributions, refunds, credits and debits in the database or databases in said SQL server in said computer server or servers comprises a process of assigning individual fees or payments to a physician or a plurality of physicians providing health care and health-care services comprising evaluations, laboratories, testings, treatments and/or surgeries, to individual patients wherein evaluations, treatments, surgeries and laboratories and testings effecting the payments, continual distributions and adjustments of proportional reductions of payments, distributions or credits to or, conversely, proportional debits from the accounts of individual physicians evaluating and treating individual patients and establishing individual diagnoses and performing evaluations, treatments, surgeries and laboratories and testings and, consequently, based on said circumstances, debit or credit accounts of patients and health-care buyers.

14. The method for patterning dispensations of health care and health-care services to patients of or by physicians and patterning utilizations of health care and health-care services of or by patients and for managing physicians' dispensations of health care and health-care services and compensations and patients' utilizations of health care and health-care services and health-care fund disbursements according to claim 2 wherein a process of using said words and terms to effect the generations, managements and maintenances of accounts of physicians comprising information and data on distributions, adjustments, redistributions, refunds, credits and debits in the database or databases in said SQL server comprises a process of generating individual payments and applicable subsequent higher or lower adjustments to said individual payments or redistributions of payments pertaining or relating to individual correct, preliminary, provisional or wrong diagnoses and relating evaluations, treatments, surgeries and laboratories and testings or any combinations thereof established, ascertained and/or used by physicians involving in said establishments or ascertains and corresponding higher or lower adjustments of payments to said physicians and, based on said circumstances and individual involvements of individual physicians providing individual health-care services to individual patients on or relating to individual diagnoses or individual involvements of individual series of physicians providing health-care services within same medical or surgical specialty or of diverse and different medical and/or surgical specialties and, consequently and correspondingly, crediting or debiting the funds in the accounts of patients and health-care buyers.

15. The method for patterning dispensations of health care and health-care services to patients of or by physicians and patterning utilizations of health care and health-care services of or by patients and for managing physicians' dispensations of health care and health-care services and compensations and patients' utilizations of health care and health-care services and health-care fund disbursements according to claim 2 wherein said process of patterning the dispensations of health care and health-care services to patients of or by physicians and said process of patterning the utilizations of health care and health-care services of or by patients in said computer server or said computer servers comprises a process of retrieving, displaying on Web pages and using said interactive medical words and terms representing diagnoses on or relating to individual patients by and interactive with physicians and patients to retrieve, display on Web pages and use scientific and medical information and data, journals and literatures, discussions, arguments on or relating to said diagnoses and related treatments, surgeries and laboratories and testings, cost-effectiveness, cost effects, revenue effects, medical and legal issues, comments and warnings to patients and physicians to affected physicians to patients and/or physicians.

16. In a system for patterning and managing the dispensations of health care and health-care services to patients of or by physicians and for patterning and managing the utilizations of health care and health-care services of or by patients and for managing physicians' compensations for health care and health-care services provided to patients and for managing patients' and health-care buyers' health-care funds and disbursements, a method for patterning and managing the dispensations of health care and health-care services to patients of or by physicians and patterning and managing the utilizations of health care and health-care services of or by patients and for managing physicians' compensations for health care and health-care services provided to patients and for managing patients' and health-care buyers' health-care funds and disbursements in a network or networks of computers, portable and/or wireless communication devices and operating and functioning computer servers comprising a plurality of processors, memories, server operating system, a networking capability comprising a Web browser and Web server, SQL server, computer scripting language programs and innovative computer programs and software communicating with and commanding said SQL server using words and terms which are components of health, health-care and health-care-service information and data on or relating to diseases and disorders and patients used and use by physicians of all and diverse medical and surgical practices or specialties for and in the communications of said information and data among and between physicians and between physicians and patients to generate and submit information and data on health, health care and health-care services provided to patients by physicians to be stored, related and compiled or pooled in the database or databases in and manage by said SQL server, using information and data including words and terms on or relating to health care and health-care services generated, submitted, stored, related, compiled or pooled in the database or databases in and manage by said SQL server by physicians, using information and data including said words and terms on or relating to health, health care and health-care services provided to patients by physicians generated and submitted by physicians and stored, related and compiled or pooled in the database or databases in and manage by said SQL server, scanning information and data including words and terms generated and/or used and submitted by physicians and words and terms same as, similar to and/or equivalence of said words and terms and relating monetary values, prices or costs in the database or databases in said SQL server, scanning generated and/or used and submitted information and data including said words and terms and checking for redundant repeats, doubles or similars and/or errors wherein errors can be and are corrected by physicians and/or patients, matching said words and terms generated and/or used and submitted by physicians with words and terms same as, similar and/or equivalent to said words and terms in the database or databases in said SQL server and matching words and terms generated and/or used and submitted by physicians with words and terms same as, similar and/or equivalent to said words and terms and relating monetary values, prices or costs of said health care and health-care services generated, submitted and store in the database or databases in and manage by said SQL server and generating, submitting, storing and relating, compiling or pooling and using said information and data including said words and terms and the information and data products and outcomes of said uses, scans and matches in the database or databases in and manage by said SQL server to generate, submit and manage information and data on health, health care and health-care services and relating payments, distributions, redistributions of payments, disputes, appeals, credits, debits, refunds, balances, revenues and earnings of individual physicians and debits, credits, refunds, deductions and/or disbursements from patients' and/or health-care buyers' deposits and/or funds corresponding to said payments, compensations and/or distributions to said physicians by and/or on the behalf of said patients and by and/or on the behalf of said health-care buyers are generated, stored, related and managed in said SQL server and to automatically generate or create and manage resultant information and data outcomes and products on or relating to payments or compensations for health-care and health-care services provided to patients by physicians and to retrieve and display said resultant information and data outcomes and products on and relating to payments or compensations for health-care and health-care services and on the deposits of funds and debits, deductions and/or disbursements from patients' and/or health-care buyers' deposits and/or funds corresponding to said payments or compensations to said physicians by and/or on the behalf of said patients and by and/or on the behalf of said health-care buyers in the database or databases in and manage by said SQL server in said computer server or servers, using said words and terms to inform physicians of erroneous words and terms generated and submitted by said physicians, to change, correct or edit erroneous words and terms by physicians and to enable patients to dispute payments, hold payments in abeyance, enable physicians to respond to patients' disputes, implement payments to physicians, producing, retrieving, displaying, showing and effecting the uses of said information and data including said words and terms by physicians and patients, producing, retrieving, displaying and effecting the uses of the interactive medical words and terms representing diagnoses on or relating to individual patients to and interactive with physicians and patients to access, display, manage, use and expand information and data on health, health-care and health-cares services, producing, retrieving, displaying and using arrays or series of information and data on individual related health, health-care and health-care services and related payments, distributions, disbursements, disputes, appeals, credits, refunds and balances in the database or databases in and manage by said SQL server, producing, retrieving, displaying and using individual arrays or series of related pooled and compiled information and data on individual health, health care and health-care services provided to patients and related health-care and health-care services and related payments, disbursements, disputes, appeals, credits, refunds and balances of or related to physicians and patients, automatically generating or creating and managing resultant information and data outcomes and products on or relating to payments or compensations for health-care and health-care services provided to patients by physicians, retrieving and displaying said resultant information and data outcomes and products on and relating to payments or compensations for health-care and health-care services and on the deposits of funds and debits, deductions and/or disbursements from patients' and/or health-care buyers' deposits and/or funds corresponding to said payments or compensations to said physicians by and/or on the behalf of said patients and by and/or on the behalf of said health-care buyers in the database or databases in and manage by said SQL server, effecting the automatic generations, managements and maintenances of individual payments, distributions, redistributions of payments, disputes, appeals, credits, debits, refunds, balances, revenues and earnings of individual physicians and debits, credits, refunds, deductions and/or disbursements from patients' and/or health-care buyers' deposits and/or funds corresponding to said payments or compensations to said physicians by and/or on the behalf of said patients and by and/or on the behalf of said health-care buyers in the database or databases in and manage by said SQL server, effecting the automatic generations, managements and maintenances of higher or lower adjustments to individual payments, distributions or redistributions of payments pertaining or relating to diagnoses and relating procedures and treatments wherein the resultant information and data outcomes and products on or relating to funds, payments, distributions, redistributions, adjustments, disputes, appeals, credits, debits, refunds, balances, revenues and earnings are generated, stored, related in the database or databases in and managed in said SQL server, and enabling physicians, patients and health-care buyers to use computers and/or portable electronic communication devices in a network or networks of computers, portable electronic communication devices and said computer server or servers to transmit said information and data to and to retrieve and access said information and data in the database or databases in said SQL server and enabling physicians and patients to retrieve, view, use, manage and expand said information and data via the Internet by physicians, patients and health-care buyers to effect the control of health-care resources by physicians, patients and health-care buyers, to effect and affect the patterning of physicians' dispensations of health care and health-care services to patients and the patterning of patients' utilizations of health care and health-care services, to effect the interactions and sharing of information and data and logics on health, health care and health-care services by, of and among physicians, patients, and health-care buyers to improve the practices of medicine and surgery of and by physicians, the dispensations and utilizations of health care and health-care services by physicians and patients comprises:
a process of operating a network or networks of operating and functioning computer servers comprising a plurality of processors, memories, server operating system, a networking capability comprising a Web browser, Web server, SQL server, computer scripting language programs and innovative computer programs and software communicating with and commanding said SQL server;
a process of using said computer scripting languages and innovative computer programs and software to communicate with and command said SQL server;
a process of using said computer scripting languages and innovative computer programs and software to generate, expand and manage information and data in the database or databases in and manage by said SQL server;
a process of using computer scripting language programs and innovative computer programs and software to communicate with and command SQL server and database or databases and Web browser;
a process of coupling a Web browser to said innovative computer programs and software and said SQL server and databases in said computer server or servers;
a process of using said computer scripting languages and innovative computer programs and software for retrieving and displaying on Web pages said information and data in said database or databases in and manage by said SQL server;
a process of using a Web browser to retrieve and view said information and data by physicians and/or patients;
a process of patterning and managing the dispensations of health care and health-care services to patients of or by physicians and patterning and managing the utilizations of health care and health-care services of or by patients and of managing physicians' compensations for health care and health-care services provided to patients and for managing patients' and health-care buyers' health-care funds and disbursements;
a process of generating, maintaining, expanding and implementing the database or databases in said SQL server;
a process of relating and compiling the information and data in the database or databases in said SQL server;
a process of using said computer scripting language programs and innovative computer programs and software for generating, storing, relating and managing said information and data in said databases in and manage by said SQL server;
a process of using said computer scripting languages and innovative computer programs and software to generate, relate and manage health, health-care and health-care-service information and data and the health, health-care and health-care-services information and data products and outcomes of the generations, relations, managements and uses of said information and data in the database or databases which are submitted, stored, related, compiled or pooled in said database or databases in and manage by said SQL server;
a process of generating, relating and managing health, health-care and health-care-service information and data and the health, health-care and health-care-service information and data products and outcomes of the generations, relations, managements and uses of said information and data in the database or databases which are submitted, stored, related, compiled or pooled in said database or databases in and manage by said SQL server;
a process of using said computer scripting languages and innovative computer programs and software to generate, relate and manage said information and data and said products and outcomes and to retrieve, display on Web pages, and to effect the views and uses of said information and data and products and outcomes by patients and physicians;
a process of generating, relating, managing and using said information and data and products and outcomes of said processes;
a process of generating, maintaining and expanding information and data and the information and data outcomes and products in the database or databases in and manage by said SQL;
a process of retrieving, displaying and using words and terms which are components of health, health-care and health-care-service information and data on or relating to diseases and disorders and patients and are used by physicians of all and diverse medical and surgical practices or specialties for and in the communications of said information and data among and between physicians and between physicians and patients are generated, submitted, stored, related, compiled in the database or databases in and manage by said SQL server;
a process of retrieving, displaying and using said words and terms to generate, manage, relate, display, use, expand and improve information and data on health, health-care and health-care-services;
a process of retrieving, displaying and using said words and terms to generate, manage, relate, display, use, expand and improve information and data on health, health-care and health-care-services and on or relating health-care funds, payments, distributions, redistributions, adjustments, disputes, appeals, credits, debits, refunds, balances, revenues and earnings of physicians, patients and health-care buyers;
a process of retrieving and displaying and using said interactive medical words and terms representing diagnoses on or relating to individual patients to and interactive with physicians and patients to retrieve, display, use, expand, improve and manage said information and data on health, health-care and health-care-services in the database or databases in and manage by said SQL server;
a process of retrieving and displaying and using said interactive medical words and terms representing diagnoses on or relating to individual patients to and interactive with physicians and patients to retrieve, display, use, expand, improve and manage said information and data on health, health-care and health-care-services and on or relating health-care funds, payments, distributions, redistributions, adjustments, disputes, appeals, credits, debits, refunds, balances, revenues and earnings of physicians, patients and health-care buyers;
a process of retrieving, displaying and using information and data on health, health care and health-care services and relating prices, monetary values or costs generated, submitted, stored, related and compiled in the database or databases in and manage by said SQL server;
a process of retrieving, displaying and using information and data on health, health care and health-care services and relating funds, payments, distributions, redistributions, adjustments, disputes, appeals, credits, debits, refunds, balances, revenues and earnings of physicians, patients and health-care buyers generated, stored, related, compiled in the database or databases in and managed by said SQL server;
a process of generating, submitting, storing, relating, compiling and pooling words and terms which are components of health, health-care and health-care-service information and data on or relating to diseases and disorders and patients and are used by physicians of all and diverse medical and surgical practices or specialties for and in the communications of said information and data among and between physicians and between physicians and patients in the database or databases in and manage by said SQL server;
a process of generating, submitting, storing, relating, compiling and pooling information and data including said words and terms on or relating to health, health care and health-care services provided to patients by physicians which are generated and/or used and submitted by physicians and patients in the database or databases in and manage by said SQL server;
a process of generating, submitting and relating words and terms same as, similar to and/or equivalence of said words and terms in the database or databases in said SQL server;
a process of generating, submitting and storing words and terms same as, similar to and/or equivalence of said words and terms and relating monetary values representing prices, monetary values or costs of said health-care and health-care services in the database or databases in said SQL server;
a process of retrieving, displaying and using said words and terms by physicians and patients;
a process of retrieving, viewing and using said words and terms same as, similar to and/or equivalence of said words and terms in the database or databases by physicians and/or patients;
a process of retrieving, displaying and using said words and terms and relating monetary values representing prices, monetary values or costs of said health-care and health-care services in the database or databases in said SQL server;
a process of retrieving, viewing and using said words and terms same as, similar to and/or equivalence of said words and terms and relating monetary values representing prices or monetary values of said health-care and health-care services generated, related and stored in the database or databases in said SQL server;
a process of applying said innovative computer programs and software operating and functioning in said computer server or servers to scan said information and data and words and terms;
a process of applying said innovative computer programs and software operating and functioning in said computer server or servers to select matches of said words and terms;
a process of applying said innovative computer programs and software operating and functioning in said computer server or servers to select matches of said words and terms and relating prices, monetary values or costs of said health-care and health-care services in the database or databases in said SQL server in said computer server or servers;
a process of scanning words and terms which are components of health, health-care and health-care-service information and data on or relating to individual patients generated and submitted by said physicians to the database or databases in said SQL server in said computer server or servers and words and terms same, similar and/or equivalent to said words and terms in the database or databases in said SQL server in said computer server or servers;
a process of matching words and terms which are components of health, health-care and health-care-service information and data on or relating to individual patients generated and submitted by said physicians to the database or databases in said SQL server in said computer server or servers with words and terms same, similar and/or equivalent to said words and terms in the database or databases in said SQL server in said computer server or servers;
a process of scanning words and terms generated and/or used and submitted by physicians;
a process of scanning words and terms used by physicians retrieving said words and terms from the database or databases in said SQL server and words and terms same, similar and/or equivalence of said words and terms and relating monetary values, prices or costs in the database or databases in said SQL server in said computer server or servers;
a process of scanning words and terms used and submitted by physicians for redundant repeats, doubles or similars and/or errors;
a process of matching words and terms generated and submitted by physicians and words and terms same, similar and/or equivalence of said words and terms in said SQL server;
a process of matching words and terms generated and submitted by physicians and words and terms same, similar and/or equivalence of said words and terms and relating monetary values, prices or costs which are stored and managed in said SQL server;
a process of matching words and terms used and submitted by physicians and words and terms same, similar and/or equivalence of said words and terms and relating monetary values, prices or costs which are stored and managed in said SQL server;
a process of entering, storing and relating the products and outcomes of said scans of words and terms in the database or databases in and manage by said SQL server;
a process of entering, storing and relating the information and data outcomes and products of said matches of words and terms and selected relating prices, monetary values or costs in the database or databases in said SQL server;
a process of generating and storing said words and terms same, similar to and/or equivalence of said words and terms and relating monetary values, prices or costs generated, related, entered into and store in the database or databases in said SQL server;
a process of generating the information and data outcomes and products of matching said words and terms generated and submitted by physicians and said words and terms and relating monetary values, prices or costs which are stored and managed in said SQL server;
a process of generating the information and data outcomes and products of relating said words and terms used by physicians by retrieving said words and terms from the database or databases in said SQL server and said words and terms same, similar and/or equivalence of said words and terms and relating monetary values, prices or costs which are stored and managed in said SQL server;
a process of generating the resultant information and data outcomes and products of matching said words and terms generated and/or used by physicians with words and terms same, similar and/or equivalence of said words and terms and relating monetary values, prices or costs which are stored and managed in said SQL;
a process of storing and managing said resultant information and data outcomes and products of said matching said words and terms and relating monetary values, prices or costs in said SQL server;
a process of generating and maintaining accounts of physicians comprising information and data on payments, compensations, refunds and debits in the database or databases in said SQL server;
a process of using said words and terms to effect the generations, managements and maintenances of accounts of physicians comprising information and data on distributions, adjustments, redistributions, refunds, credits and debits in the database or databases in said SQL server;
a process of generating accounts of patients comprising deposits, debits, disbursements, refunds and credits in the database or databases in said SQL server;
a process of generating accounts of health-care buyers comprising deposits, debits, disbursements, refunds and credits in the database or databases in said SQL server;
a process of managing, accounting and displaying the deposits of and debits, deductions and/or disbursements from patients' and/or health-care buyers' deposits and/or funds corresponding to said payments or compensations to said physicians by and/or on the behalf of said patients and by and/or on the behalf of said health-care buyers in said SQL server;
a process of using said words and terms to inform and display for physicians said erroneous words and terms in said computer server or servers generate and submit by physicians;
a process of effecting changes, corrections and editions of said erroneous words and terms to correct words and terms in said computer server or servers by physicians to corrected words and terms;
a process of disputing payments and disbursements in said computer server or servers by patients;
a process of withholding payments to physicians in said computer server or servers by patients as the consequences of said patients' disputes;
a process of responding to patients' disputes and withholding of payments by physicians;
a process of implementing payments to physicians in said computer server or servers as the consequences of said physicians' responses to said patients' disputes;
a process of inserting said words and terms and relating monetary values into said physicians' accounts in the database or databases in said SQL server;
a process of inserting said words and terms and relating monetary values into said patients' accounts in the database or databases in said SQL server in said computer server or servers;
a process of relating said data the credits representing payments credited to the physicians' accounts for the health-care services provided to patients by said physicians and said data on the debits, deductions or disbursements of funds representing payments for said services to said physicians from said patients' accounts in the database or databases in said SQL server in said computer server or servers;
a process of relating said data the credits representing payments credited to the physicians' accounts for the health-care services provided to patients by said physicians and said data on the debits, deductions or disbursements of funds representing payments for said services to said physicians from said health-care buyers' accounts in in the database or databases in said SQL server in said computer server or servers;
a process of displaying said information and data on health-care and health-care services and related payments or compensations, debits, refunds, revenues and earnings to said physicians;
a process of displaying said information and data on health-care and health-care services and related deposits, debits, disbursements, refunds, credits and balances to patients;
a process of displaying data on deposits, debits or disbursements and balances to health-care buyers;
a process of correcting erroneous or inaccurate said information and data by physicians;
a process of correcting erroneous or inaccurate said information and data by physicians;
a process of feedbacks on said outcomes and/or products of said processes between said physicians and patients;
a process of managing, organizing and relating said information and data and said resultant information and data outcomes and products of said processes in the database or databases in said SQL server in said computer server or servers;
a process of viewing said information and data on payments, compensations, computations and accounting by physicians and patients;
a process of retrieving and displaying and using said individual arrays or series of said information and data on or relating to health, health-care, health-care services in the database or databases in and manage by said SQL server by physicians and patients;
a process of retrieving and displaying and using said individual arrays or series of information and data on or relating to health, health-care, health-care services and related funds, payments, distributions, redistributions, adjustments, disputes, appeals, credits, debits, refunds, balances, revenues and earnings in the database or databases in and manage by said SQL server by physicians and/or patients;
a process of using words and terms to retrieve, display and use individual arrays or series of said information and data on or relating to health, health-care, health-care services and related funds, payments, distributions, redistributions, adjustments, disputes, appeals, credits, debits, refunds, balances, revenues and earnings in the database or databases in and manage by said SQL server by physicians and/or patients;
a process of using interactive words and terms to retrieve, display and use individual arrays or series of information and data on or relating to health, health-care, health-care services and related funds, payments, distributions, redistributions, adjustments, disputes, appeals, credits, debits, refunds, balances, revenues and earnings in the database or databases in and manage by said SQL server by physicians and/or patients;
a process of retrieving, displaying and using individual arrays or series of related pooled or compiled information and data on or relating to health, health-care, health-care services in the database or databases in and manage by said SQL server by physicians and patients;
a process of retrieving, displaying and using individual arrays or series of related pooled or compiled information and data on or relating to health, health-care, health-care services and related funds, payments, distributions, redistributions, adjustments, disputes, appeals, credits, debits, refunds, balances, revenues and earnings in the database or databases in and manage by said SQL server by physicians and/or patients;
a process of using words and terms to retrieve, display and use individual arrays or series of related pooled or compiled information and data on or relating to health, health-care, health-care services and related funds, payments, distributions, redistributions, adjustments, disputes, appeals, credits, debits, refunds, balances, revenues and earnings in the database or databases in and manage by said SQL server by physicians and/or patients;
a process of using interactive words and terms to retrieve, display and use individual arrays or series of related pooled or compiled information and data on or relating to health, health-care, health-care services and related funds, payments, distributions, redistributions, adjustments, disputes, appeals, credits, debits, refunds, balances, revenues and earnings in the database or databases in and manage by said SQL server by physicians and/or patients;
a process of presenting logics on the dispensations and utilizations of health care and health-care services by physicians and patients stored and compiled in the database or databases in said SQL server and in the memory or memories of said computer server or servers to patients and physicians;
a process of using words and terms to retrieve and display logics on the dispensations and utilizations of health care and health-care services by physicians and patients stored and compiled in the database or databases in said SQL server and in the memory or memories of said computer server or servers to patients and physicians;
a process of using interactive words and terms to retrieve and display logics on the dispensations and utilizations of health care and health-care services by physicians and patients stored and compiled in the database or databases in said SQL server and in the memory or memories of said computer server or servers to patients and physicians;
a process of presenting supporting scientific and medical information and data, journals and literatures, discussions, arguments on or relating to said diagnoses and related treatments, surgeries and laboratories and testings, cost-effectiveness, cost effects, revenue effects, medical and legal issues, comments and warnings to patients and physicians;
a process of using words and terms to retrieve and display scientific and medical information and data, journals and literatures, discussions, arguments on or relating to said diagnoses and related treatments, surgeries and laboratories and testings, cost-effectiveness, cost effects, revenue effects, medical and legal issues, comments and warnings to patients and physicians;
a process of using interactive words and terms to retrieve and display scientific and medical information and data, journals and literatures, discussions, arguments on or relating to said diagnoses and related treatments, surgeries and laboratories and testings, cost-effectiveness, cost effects, revenue effects, medical and legal issues, comments and warnings to patients and physicians;
a process of relating said information and data and said information and data outcomes and products of said matches of words and terms and selected relating prices, monetary values or costs in the database or databases in said SQL server in said computer server or servers;
a process of operating and maintaining said operating and functioning computer server or servers wherein a process of implementing said computer programs and software and said networking capability, innovative computer programs and software effects the accesses, viewing and uses of said information and data and resultant information and data outcomes and products by physicians, patients and health-care buyers using computers, portable electronic communication devices via the Internet;
a process of retrieving, displaying and effecting the viewing and uses of said information and data and products and outcomes by patients and physicians;
a process of using a Web browser to retrieve and display said information and data in said database or databases in said SQL server in said computer server or servers which are viewed on Web pages appearing on said viewing screens, used and expanded by physicians and patients using said computers, portable and/or wireless communication devices to access said computer server or servers in said network or networks via the Internet; and
a process of enabling physicians and patients to retrieve, display, view, expand, manage and use said information and data and information and data outcomes and products of said scans and matches of words and terms and selected relating prices, monetary values or costs in the database or databases in said SQL server and said processes.
